(19) United States
(12) Patent Application Publication
(10) Pub. No.: US 2024/0048977 A1
(43) Pub. Date: Feb. 8, 2024

(54) DATA SIGNATURES FOR ML SECURITY

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US); Mahmoud TAHERZADEH BOROUJENI, San Diego, CA (US)

(21) Appl. No.: 17/818,315

(22) Filed: Aug. 8, 2022

(51) Int. Cl. H04W 12/06; G06N 3/08

(52) U.S. Cl. CPC H04W 12/06; G06N 3/08

(57) ABSTRACT

The network node or the core network may obtain a plurality of datasets for training a ML model, each dataset including a set of metrics collected by a corresponding UE from the at least one UE, and assign at least one data signature associated with a source of each dataset of the plurality of datasets. The network node or the core network may identify a first data signature associated with a corrupted dataset, and filter out at least one dataset associated with the first data signature from the plurality of datasets for training the ML model based on the first data signature being associated with the corrupted dataset.

### TECHNICAL FIELD

The present disclosure relates generally to communication systems, and more particularly, to a method of wireless communication including data signature assignment for machine learning (ML) security.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network node configured to obtain a plurality of datasets for training a machine learning (ML) model from at least one user equipment (UE), each dataset including a set of metrics collected by a corresponding UE from the at least one UE, and assign at least one data signature associated with a source of each dataset of the plurality of datasets.

In an aspect of the disclosure, a method, a computer-readable medium, and an apparatus are provided. The apparatus may be a core network configured to obtain a plurality of datasets for training an ML model from at least one network node, each dataset being assigned with a corresponding data signature and each data set including a set of metrics collected by a UE served by the at least one network node, identify a first data signature associated with a corrupted dataset, and filter out at least one dataset associated with the first data signature from the plurality of datasets for training the ML model based on the first data signature being associated with the corrupted dataset.

In an aspect of the disclosure, a method, a computer-readable medium, and an apparatus are provided. The apparatus may be a UE configured to receive a configuration from a network node assigning at least one data signature to be reported with a dataset for an ML model, and transmit one or more datasets for the ML model to the network node and indicating the at least one data signature for the dataset.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an example of the AI/ML algorithm of a method of wireless communication.

FIG. 5A illustrates a call-flow diagram of AI/ML model training.

FIG. 5B illustrates a call-flow diagram of AI/ML model training.

FIGS. 6A and 6B are diagrams of decision boundary in AI/ML model.

FIG. 7 is a diagram of collecting data with data signature.

FIG. 8 is a diagram of testing dataset associated with data signature with a trusted dataset.

FIG. 9 is a diagram of testing dataset associated with data signature without a trusted dataset.

FIG. 10 is a call-flow diagram of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

FIG. 18 is a diagram illustrating an example of a hardware implementation for an example network entity.

### DETAILED DESCRIPTION

A machine learning (ML) model may be provided to configure at least one network activity. The training of the ML model may have security vulnerabilities from at least one perturbed data (e.g., inaccurate data, false data, etc.) being injected or introduced into the training dataset. In some aspects, the network entity (e.g., a network node or a core network) configured with the ML model training may assign at least one data signature to the collected dataset, and identify at least one data signature associated with a corrupted dataset including the perturbed data. The network entity may filter out the dataset associated with the at least one data signature associated with a corrupted dataset.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

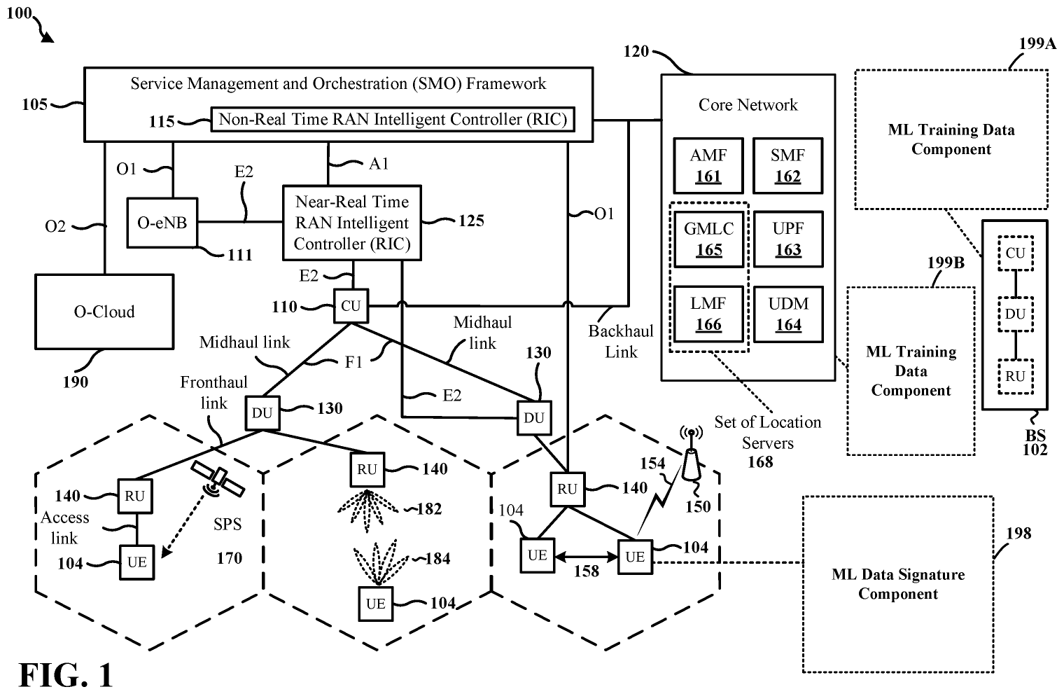

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an ML data signature component 198 configured to receive a configuration from a network node assigning at least one data signature to be reported with a dataset for an ML model, and transmit one or more datasets for the ML model to the network node and indicating the at least one data signature for the dataset. In certain aspects, the base station 102 may include an ML training data component 199A configured to obtain a plurality of datasets for training an ML model from at least one UE, each dataset including a set of metrics collected by a corresponding UE from the at least one UE, and assign at least one data signature associated with a source of each dataset of the plurality of datasets. In certain aspects, the core network 120 may include an ML training data component 199B configured to obtain a plurality of datasets for training an ML model from at least one network node, each dataset being assigned with a corresponding data signature and each data set including a set of metrics collected by a UE served by the at least one network node, identify a first data signature associated with a corrupted dataset, and filter out at least one dataset associated with the first data signature from the plurality of datasets for training the ML model based on the first data signature being associated with the corrupted dataset. Although the following description may be focused on 5G NR, the concepts described herein may be applicable to other similar areas, such as LTE, LTE-A, CDMA, GSM, and other wireless technologies.

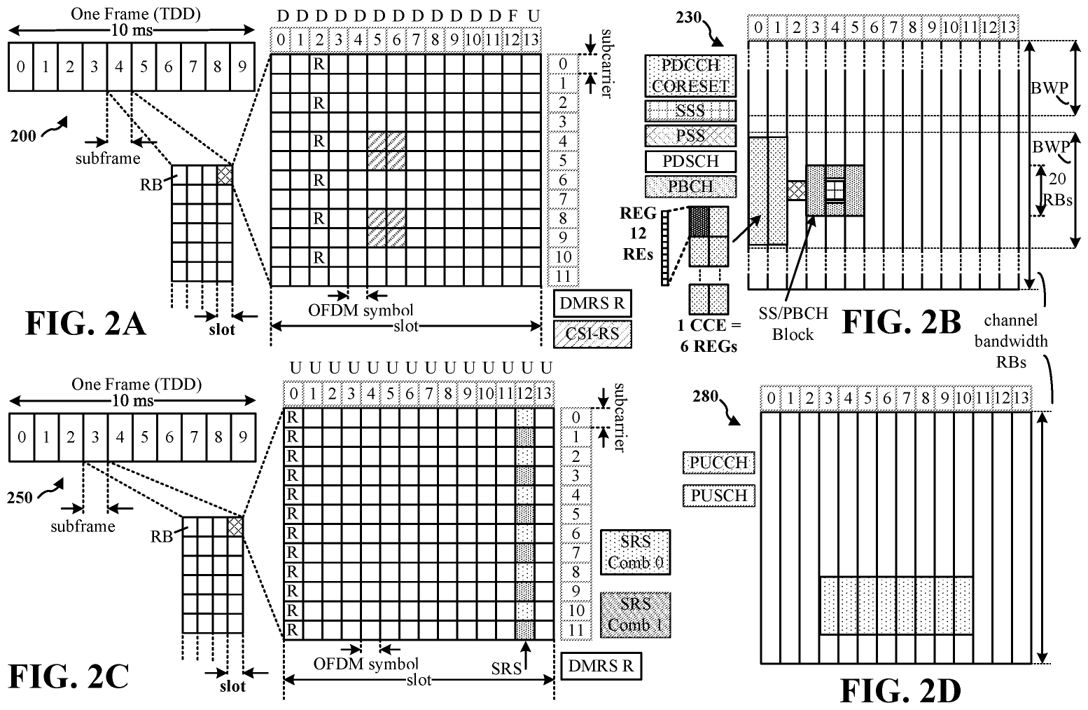

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (B SR), a power headroom report (PHR), and/or UCI.

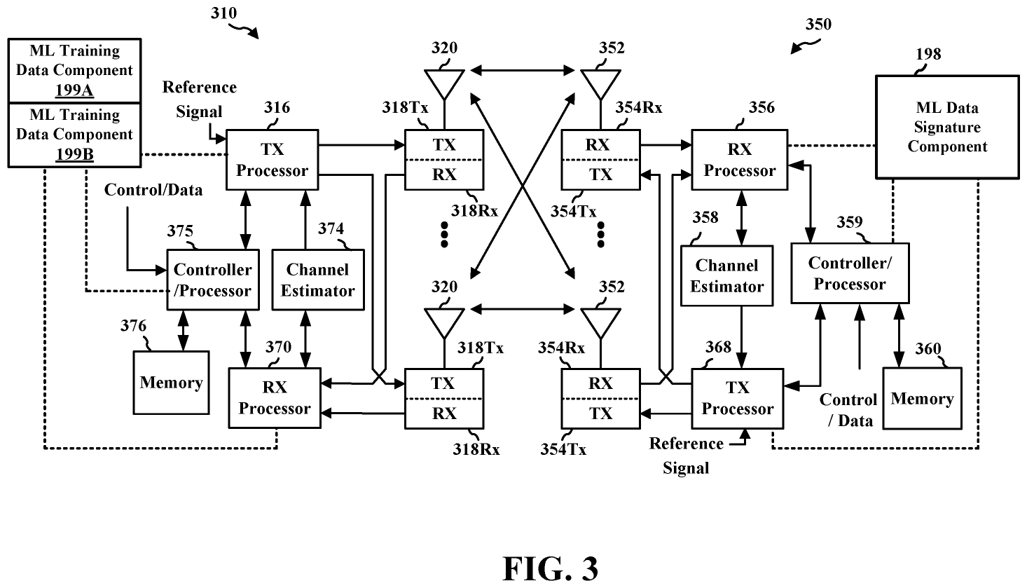

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the ML data signature component 198 of FIG. 1. At least one of the TX processor 316, the RX processor 370, and the controller/processor 375 may be configured to perform aspects in connection with the ML training data component 199A of FIG. 1. At least one of the TX processor 316, the RX processor 370, and the controller/processor 375 may be configured to perform aspects in connection with the ML training data component 199B of FIG. 1.

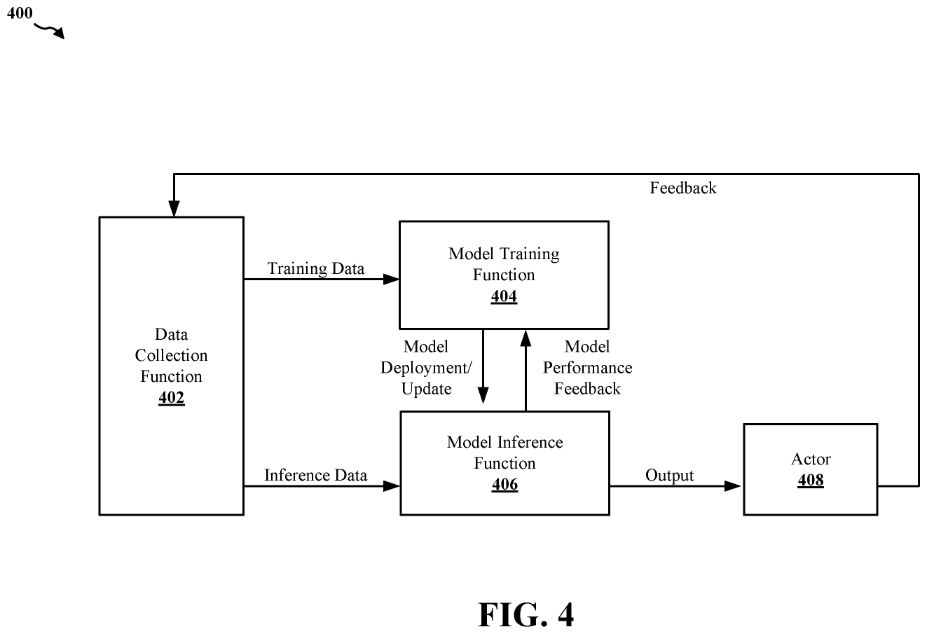

FIG. 4 is an example of the AI/ML algorithm 400 of a method of wireless communication. Here, the AI/ML algorithm 400 may be included in either the UE or the network node (e.g., the source network node or the target network node of the handover procedure) to provide the AI/ML based mobility related prediction. The AI/ML algorithm 400 may include various functions including a data collection function 402, a model training function 404, a model inference function 406, and an actor 408.

The data collection function 402 may be a function that provides input data to the model training function 404 and the model inference function 406. The data collection function 402 may include any form of data preparation, and it may not be specific to the implementation of the AI/ML algorithm (e.g., data pre-processing and cleaning, formatting, and transformation). The examples of input data may include, but not limited to, measurements from network entities including UEs or network nodes, feedback from the actor 408, output from another AI/ML model. The data collection function 402 may include training data, which refers to the data to be sent as the input for the model training function 404, and inference data, which refers to be sent as the input for the model inference function 406.

The model training function 404 may be a function that performs the ML model training, validation, and testing, which may generate model performance metrics as part of the model testing procedure. The model training function 404 may also be responsible for data preparation (e.g. data pre-processing and cleaning, formatting, and transformation) based on the training data delivered or received from the data collection function 402. The model training function 404 may deploy or update a trained, validated, and tested AI/ML model to the model inference function 406, and receive a model performance feedback from the model inference function 406.

The model inference function 406 may be a function that provides the model inference output (e.g. predictions or decisions). The model inference function 406 may also perform data preparation (e.g. data pre-processing and cleaning, formatting, and transformation) based on the inference data delivered from the data collection function 402. The output of the model inference function 406 may include the inference output of the AI/ML model produced by the model inference function 406. The details of the inference output may be use-case specific.

The model performance feedback may refer to information derived from the model inference function 406 that may be suitable for improvement of the AI/ML model trained in the model training function 404. The feedback from the actor 408 or other network entities (via the data collection function 402) may be implemented for the model inference function 406 to create the model performance feedback.

The actor 408 may be a function that receives the output from the model inference function 406 and triggers or performs corresponding actions. The actor 408 may trigger actions directed to network entities including the other network entities or itself. The actor 408 may also provide a feedback information that the model training function 404 or the model inference function 406 to derive training or inference data or performance feedback. The feedback may be transmitted back to the data collection function 402.

A UE and/or network entity (centralized and/or distributed units) may use machine-learning algorithms, deep-learning algorithms, neural networks, reinforcement learning, regression, boosting, or advanced signal processing methods for aspects of wireless communication, e.g., with a base station, a TRP, another UE, etc.

In some aspects described herein, an encoding device (e.g., a UE) may train one or more neural networks to learn dependence of measured qualities on individual parameters. Among others, examples of machine learning models or neural networks that may be comprised in the UE and/or network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

In some aspects, a network environment may include a UE, a first network node, a second network node, and a core network (e.g., an operation, administration, and maintenance (OAM) entity), and the UE, the first network node, the second network node, and the core network may configure various network activity using at least one AI/ML model. Here, the AI/ML model may be included in the second network node.

In one example, the UE, the first network node, the second network node, and/or the core network may be configured to perform network energy saving using at least one AI/ML model. The at least one AI/ML model configured for network energy saving may perform a cell activation/deactivation, (e.g., switching off some cells with low traffic), a traffic offloading (e.g., offloading served UEs of deactivated cells to a new target cell), a reduction of the network load, or a coverage modification.

In another example, the UE, the first network node, the second network node, and/or the core network may be configured to perform a load balancing using at least one AI/ML model. The at least one AI/ML model configured for network energy saving may distribute load evenly among cells and among areas of cells, transfer part of the traffic from congested cells or from congested areas of cells, or offload users from one cell, cell area, carrier or RAT to improve network performance. The at least one AI/ML model may optimize handover parameters and handover actions.

In another example, the UE, the first network node, the second network node, and/or the core network may be configured to perform a mobility optimization using at least one AI/ML model. The at least one AI/ML model configured for network energy saving may perform a prediction of a UE location, mobility, or performance. The at least one AI/ML model may also perform a traffic steering.

Other example AI/ML models may be used for CSI feedback (e.g., with overhead reduction and improved accuracy and prediction), beam management (e.g., with a beam prediction in a time and/or spatial domain for overhead and latency reduction along with improved accuracy of beam selection), positioning accuracy improvements for different scenarios such as non-line of sight conditions.

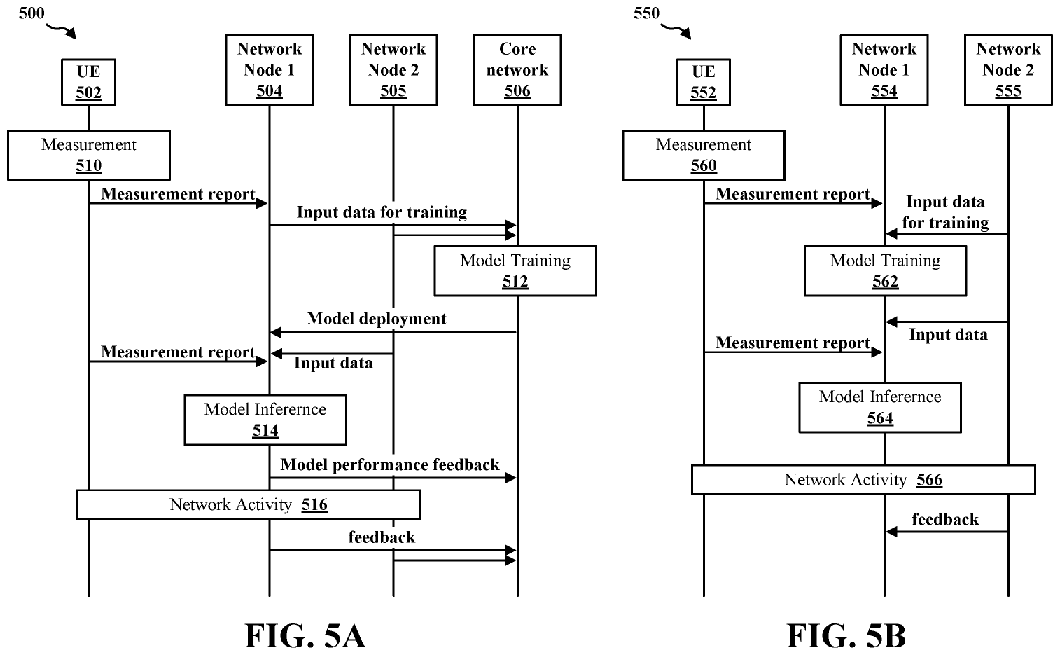

FIG. 5A illustrates a call-flow diagram 500 of AI/ML model training. The diagram 500 may include a UE 502, a first network node 504, a second network node 505, and a core network 506. Here, the UE 502, the first network node 504, and the second network node 505 may perform a network activity at 506, and the network activity may be configured using an AI/ML model. In this example, the model training (e.g., model training function 404) may be performed by the core network 506, and the model inference (e.g., model inference function 406) may be performed by the first network node 504. To train the AI/ML model, the UE 502 may obtain a set of measurement at 510 and send the measurement report to the first network node 504. The first network node 504 may transmit the measurement reports received from a plurality of UEs including the UE 502 to the core network 506 as the input data for training the AI/ML model. In the same manner, the second network node 505 may transmit the measurement reports received from a plurality of UEs to the core network 506 as the input data for training the AI/ML model. At 512, the core network 506 may train the AI/ML model using the input data received from the first network node 504 and the second network node 505.

The core network 506 may transmit the result of the AI/ML model training as an AI/ML model deployment to the first network node 504. The first network node 504 may apply the result of the AI/ML model training received from the core network 506 to the AI/ML model. The first network node 504 may receive measurement report from the UE 502 or other input data from the second network node 505 and run the AI/ML model to perform the AI/ML model inference at 514. In response to the result of the AI/ML model inference at 514, the first network node 504 may transmit a feedback of the model performance to the core network 506 to fine-tune the model training.

At 516, based on the AI/ML model, the UE 502, the first network node 504, and the second network node 505 may perform the network activity. For example, the network activity may include at least one of a network energy saving, a load balancing, or a mobility optimization. The first network node 504 and the second network node 505 may provide feedback of the network activity performed at 516 to the core network 506.

FIG. 5B illustrates a call-flow diagram 550 of AI/ML model training. The diagram 550 may include a UE 552, a first network node 554, and a second network node 555. Here, the UE 552, the first network node 554, and the second network node 555 may perform a network activity at 566, and the network activity may be configured using an AI/ML model. In this example, the model training (e.g., model training function 404) may be performed by the first network node 554, and the model inference (e.g., model inference function 406) may be performed by the first network node 554. To train the AI/ML model, the UE 552 may obtain a set of measurement at 560 and send the measurement report to the first network node 554. The second network node 555 may also transmit the measurement reports received from a plurality of UEs to the first network node 554 as the input data for training the AI/ML model. At 562, the first network node 554 may train the AI/ML model using the input data received from the UE 552 and the second network node 555.

The first network node 554 may apply the result of the AI/ML model training to the AI/ML model. The first network node 554 may receive measurement report from the UE 552 or other input data from the second network node 555 and run the AI/ML model to perform the AI/ML model inference at 564. In response to the result of the AI/ML model inference at 564, the first network node 554 may fine-tune the model training.

At 566, based on the AI/ML model, the UE 552, the first network node 554, and the second network node 555 may perform the network activity. For example, the network activity may include at least one of a network energy saving, a load balancing, or a mobility optimization. The second network node 555 may provide feedback of the network activity performed to the first network node 554.

In some aspects, the AI/ML models may have certain vulnerabilities. In one aspect, the AI/ML model may be sensitive to the statistics of input data (e.g., the model training and the model inference). The AI/ML models may be configured to be continuously updated to account for the newly generated data, and because the newly generated or introduced data may affect the configuration or the parameter of the AI/ML models, small perturbations to the input to the AI/ML model may significantly change the output of the AI/ML model.

In another aspect, the AI/ML models may have certain security vulnerabilities. That is, an adversarial UE (or corrupted UE) may tamper with the learning process (e.g., the model training and the model inference) and deceive the ML algorithms into making errors. Particularly, the complex decision space of deep learning may be sensitive to small adversarial inputs, and verifying the AI/ML models may not be cost effective.

In another aspect, depending on the AI/ML model use cases, the data collection process may be performed at the UE side (e.g., through measuring some reference signals), at the network node side, or using a cooperation between the network node and the UE. Here, the data collected at different UEs may be formed into database and shared later with at least one network node to train a global model that accounts for different environmental conditions. Furthermore, multiple network nodes and/or other core network entities (e.g., OAM) may be configured to exchange data or model updates to train a robust AI/ML model that may work in different settings. For example, in a federated learning configuration, multiple UEs may train their local models and share the model updates with the network node.

Accordingly, when an adversarial UE may inject perturbed (e.g., inaccurate or false) data or perturbed model updates to intentionally mislead the AI/ML model at the network node or the core network entity, the AI/ML model may be adversely affected by the perturbed data or perturbed model updates injected by the adversarial UE. The negative or adversarial affect from the poisoned (e.g., inaccurate or false) data may propagate to other network nodes and the core network entities. Furthermore, in the federated learning case, the adversarial UE may have a good knowledge of the AI/ML model used in taking the decision at the network node or the core network entities, and the adversarial UE may better optimize the attack (e.g., the data perturbation) based on the knowledge to confuse the AI/ML model.

According to some aspects, current disclosure may provide a method to address a causative attack (which may be referred to as poisoning attacks) to the AI/ML models. That is, some aspects of the current disclosure may be configured to identify and filter out the corrupted dataset including the perturbed data from the training data that may be used in training the AI/ML models. That is, the dataset associated with the data signature identified to be associated with corrupted dataset may not be used in the training the AI/ML models.

An adversarial UE may refer to a hostile UE that may intentionally share perturbed data (e.g., poisoning attack) or a legitimate UE with unclean data (e.g., caused by a malfunction in the UE) which may lead to poisoning the data pool. The poisoning attack may refer to an AI/ML attack of an adversarial UE injecting perturbed data into the model's training pool and the AI/ML model trained using the training data including the perturbed data may make or cause errors and its performance may be significantly impacted. The results of the poisoning attack may include a shifting of the AI/ML model's decision boundary.

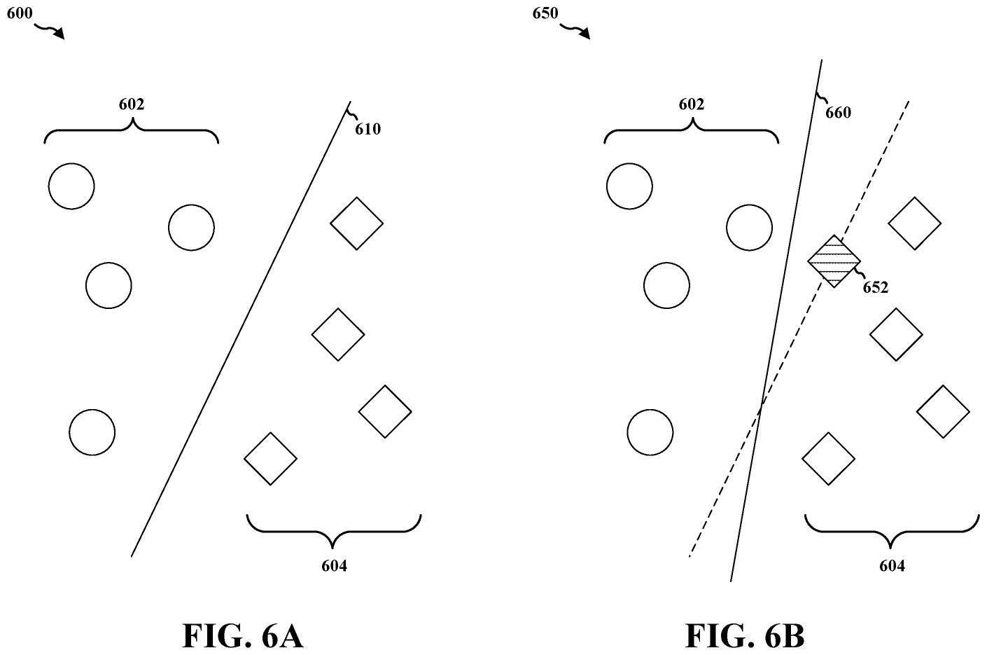

FIGS. 6A and 6B are diagrams 600 and 650 of decision boundary in AI/ML model. The diagram 600 shows that the AI/ML model is trained using a set of training data including a first subset of data 602 with a first data attribute and a second subset of data 604 with a second data attribute. Based on the set of training data including the first subset of data 602 with the first data attribute and the second subset of data 604 with the second data attribute, the AI/ML model may determine the boundary of decision 610.

The diagram 650 shows the effect of a perturbed data 652. Here, the adversarial UE may inject the perturbed data 652 to the training data. Based on the corrupted training data including the first subset of data 602 with the first data attribute and the second subset of data 604 and the perturbed data 652 with the second data attribute, the decision boundary may shift from 610 to 660, significantly affecting the performance of the AI/ML model. Accordingly, the adversarial UE may inject a single data point (e.g., the perturbed data 652), and the perturbed data 652 injected close to the decision boundary may significantly distort the AI/ML model's decision boundary.

In some aspects, the poisoning attacks may have at least one of the two following goals. In one aspect, the poisoning attacks may focus on reliability attacks. The reliability attacks may refer to attacks aim to inject multiple perturbed data into the data pool that would result in changing the model boundaries and affect the overall performance of the AI/ML model. For example, one example showed that poisoning 3% of the training dataset may reduce the accuracy performance by 11%.

In another aspect, the poisoning attacks may have the purpose of targeted attacks. Here, the adversarial UE may aim to induce a definite prediction from the machine learning model (e.g., generating a backdoor in the AI/ML model). That is, the adversarial UE may try to distort the AI/ML model to generate targeted outcomes for certain data input as the adversarial UE aims. The targeted attack may change the behaviors of the AI/ML model on some specific data instances chosen by the attackers while keeping the model performance on the other data instances unaffected so that the model's designer may remain unaware of the attack. In case corrupted (or unclean) data may be unintentionally introduced, the outcome of the AI/ML may be lead to the same results.

Aspects presented herein enable the detection of corrupted datasets, and sources of corrupted datasets, from the training dataset so that the corrupted datasets may be excluded from the training and/or the testing, regardless whether the introduction of the corrupted dataset (e.g., including the perturbed data) was intentionally introduced by a hostile UE or unintentionally introduced by a malfunctioning UE.

In some aspects, the adversary UE may provide a subset of data in the dataset, or data sources. For example, when the dataset includes a database of data from a plurality of UEs, the adversary UE may perturb its own data measurements. However, the adversary UE may not be able to directly corrupt the data collected and reported by other UEs in the plurality of UEs. Accordingly, data collected from each of the plurality of UEs may be associated with at least one data signature, and the network node or the core network may be able to identify and track the perturbed or unclean data based on the associated data signature. The network node or the core network may track data from a UE and may check to ensure that the signature information collected with the data is secured.

In some aspects, the data signature may be associated with the UE collecting or generating the dataset. For example, the data signature may include time of the data collection, location of the data collection, an identifier (ID) of the corresponding UE (e.g., IMSI, IMEI) associated with the dataset (e.g., participated in collecting the measurements or the data collection in general), an ID of the network node, a power class of the corresponding UE (e.g., class1, class2, class3, or class4), a vendor of the corresponding UE, a component (e.g., modem) of the corresponding UE, an age of the corresponding UE, or a model or a type of a sensor that collected the dataset.

In one example, the perturbed data may be associated with the adversarial UE. That is, the adversarial UE may be intentionally injecting or unintentionally introducing the perturbed data into the dataset. Based on the data signature associated with the ID of the corresponding UE, the network node or the core network may test the dataset including the perturbed data and identify the data signature associated with the ID of the adversarial UE. When training the AI/ML models, the network node or the core network may disregard the data associated with the data signature identified to be associated with the corrupted dataset including the perturbed data.

In one example, the perturbed data may be associated with the time or location of the data collection. That is, the perturbed data may be intentionally injected or unintentionally introduced into the dataset at a certain time or in a certain location. Based on the data signature associated with the time or location of the data collection, the network node or the core network may test the dataset including the perturbed data and identify the data signature associated with the time or location of the collection of the perturbed data. When training the AI/ML models, the network node or the core network may disregard the data associated with the data signature identified to be associated with the corrupted dataset including the perturbed data, e.g., filtering out data with the corresponding data signature.

In another example, the perturbed data may be associated with a network node. That is, the network node may have an issue of producing a corrupted dataset due to malfunctioning or an environmental issue. Based on the data signature associated with the ID of the corresponding network node, the core network may test the dataset including the perturbed data and identify the data signature associated with the ID of the network node. When training the AI/ML models, the core network may disregard the data associated with the data signature identified to be associated with the corrupted dataset including the perturbed data.

In another example, the perturbed data may be associated with a vendor of the corresponding UEs. That is, a set of UEs commonly manufactured by the vendor may be intentionally injecting or unintentionally introducing the perturbed data into the dataset. Based on the data signature associated with the ID of the vendor of the corresponding UEs, the network node or the core network may test the dataset including the perturbed data and identify the data signature associated with the ID of the vendor of the adversarial UEs. When training the AI/ML models, the network node or the core network may disregard the data associated with the data signature identified to be associated with the corrupted dataset including the perturbed data.

In another example, the perturbed data may be associated with the model or the type of the sensor that collected the dataset. That is, the sensor of a certain model or a type may be intentionally injecting or unintentionally introducing the perturbed data into the dataset. Based on the data signature associated with the model or the type of the sensor that collected the dataset, the network node or the core network may test the dataset including the perturbed data and identify the data signature associated with the model or the type of the sensor that collected the corrupted dataset. When training the AI/ML models, the network node or the core network may disregard the data associated with the data signature identified to be associated with the corrupted dataset including the perturbed data.

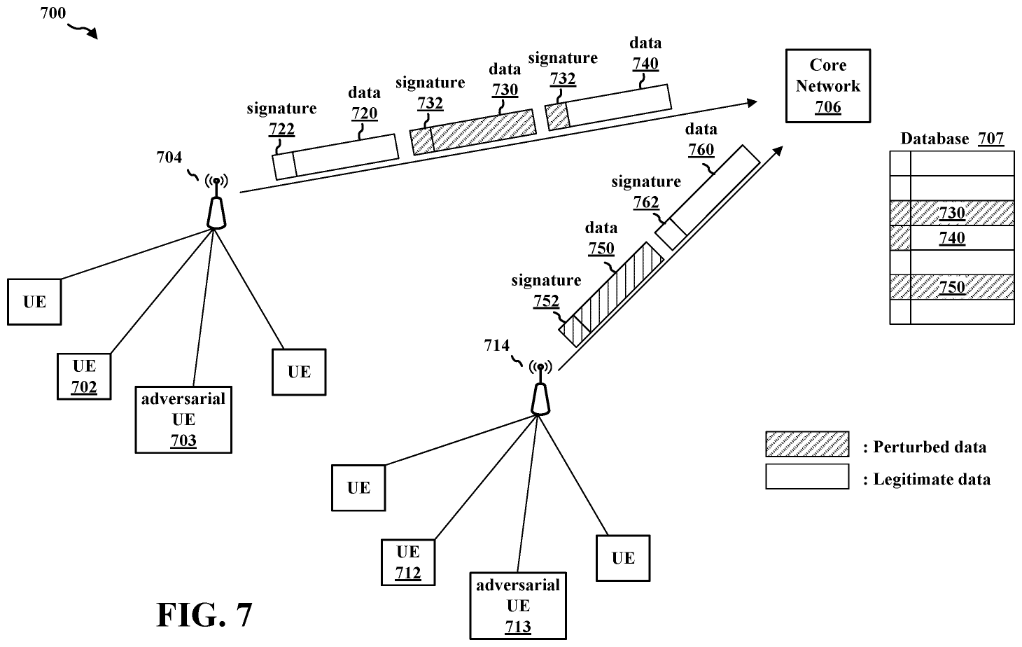

FIG. 7 is a diagram 700 of collecting data with data signature. The diagram 700 may include a first network node 704 serving a first UE 702 and a first adversarial UE 703 and a second network node 714 serving a second UE 712 and a second adversarial UE 713. The first network node 704 and the second network node 714 may collect data from the associated UEs and transmit the dataset to the core network 706.

In some aspects, the first network node 704 and the second network node 714 may be configured to add or assign a data signature to received data or to configure the associated UEs (e.g., the sources of the data) to add the data signature to the data before sending the data to the network. In one aspect, the first network node 704 may receive the data from the first UE 702 and the first adversarial UE 703 and assign the data signature associated with the first UE 702 and the first adversarial UE 703, and the second network node 714 may receive the data from the second UE 712 and the second adversarial UE 713 and assign the data signature associated with the second UE 712 and the second adversarial UE 713. In another aspect, the first network node 704 may instruct the first UE 702 and the first adversarial UE 703 to assign the data signature associated with the first UE 702 and the first adversarial UE 703 to the data, and the second network node 714 may instruct the second UE 712 and the second adversarial UE 713 to assign the data signature associated with the second UE 712 and the second adversarial UE 713.

For example, the first data 720 may be collected or generated by the first UE 702, and the second data 730 and the third data 740 may be collected or generated by the first adversarial UE 703. The fifth data 760 may be collected or generated by the second UE 712, and the fourth data 750 may be collected or generated by the second adversarial UE 713. Accordingly, the first data 720 may be assigned with a first data signature 722 associated with the first UE 702, and the second data 730 and the third data 740 may be assigned with a second data signature 732 associated with the first adversarial UE 703. The fifth data 760 may be assigned with a fifth data signature 762 associated with the second UE 712, and the fourth data 750 may be assigned with a fourth data signature 752 associated with the second adversarial UE 713.

The core network 706 may collect the first data 720, the second data 730, the third data 740, the fourth data 750, and the fifth data 760 from the first network node 704 and the second network node 714 to form the database 707. The core network 706 may be configured to collect the data from the same UE at different times and locations. The network nodes (e.g., the first network node 704 and the second network node 714) may not detect the perturbed data (e.g., the second data 730 and the fourth data 750) during the data collection process. After collecting an amount of data, the core network 706 may utilize the data signatures to identify the noisy data or the perturbed data.

Although both of the second data 730 and the third data 740 were generated or collected by the adversarial UE 703, not all of the data is perturbed data. For example, the second data 730 is perturbed data while the third data 740 is legitimate data. That is, the adversarial UE 703 may be intentionally injecting the perturbed data (e.g., the second data 730) into a database 707 at the core network 706 along with other legitimate data or the adversarial UE 703 may be unintentionally introducing the perturbed data (e.g., the second data 730) into the database 707, e.g., due to a faulty sensor. In any case, by assigning the data signature to the collected data, the network node (e.g., the first network node 704 or the second network node 714) or the core network 706 may filter out the perturbed data (e.g., the second data 730 and the fourth data 750) along with the legitimate data (e.g., the third data 740) collected by the first adversarial UE 703.

In some aspects, the network node or the core network may identify the perturbed data based on the data signatures. In one aspect, the network node or the core network may filter the database for the data associated with a specific data signature (e.g., the data signature associated with specific UE(s) or collected at a specific location) and use the filtered data in training the AI/ML model. Then, the network node or the core network may test the model performance on a trusted dataset for verification. If the AI/ML model performance is unexpectedly low, e.g., below a threshold, then the network node or the core network may be less confident about the legitimacy of the data associated with this data signature.

In another aspect, to verify the data, the network node or the core network may test the performance of the data associated with the specific data signature on a previously trained AI/ML model with trusted data. The network node or the core network may compare the distribution and the statistical properties of the data associated with a specific signature with the distribution and statistical properties of other trusted data (e.g., generated under similar environments).

In another aspect, the network node or the core network may verify the data associated with the specific data signature without the trusted data. The network node or the core network may compare the distribution and the statistical properties of the data associated with different data signatures. Then the network node or the core network may detect abnormalities in the data associated with a specific signature compared to the data associated with other signatures. Particularly, the network node or the core network may divide (or group) the collected data based on the associated data signatures and train different AI/ML models with different subsets of data signatures. Here, the AI/ML models trained using a group of data including the perturbed data may be substantially lower than the other trained AI/ML models. Therefore, the network node or the core network may check the performance of the trailed AI/ML models, and identify the perturbed data based on the performance of the AI/ML models.

Here, because the data and/or the dataset are assigned with the data signatures, the network node or the core network may track and/or group similar datasets together to verify the legitimacy of the data or the dataset, and further may refrain from applying the perturbed data in training the AI/ML models. Therefore, the network node or the core network may identify the adversarial/corrupted datasets based on the data signatures associating to the collected data.

The network node or the core network may first filter the database to generated a first dataset associated with a first data signature. The network node or the core network may test the first dataset to identify whether the first data signature associated with the first dataset is associated with the corrupted dataset. That is, if the test result on the first dataset shows that the first dataset is a corrupted dataset, the network node or the core network may identify that the first data signature is associated with a corrupted dataset, and do not use the data associated with the first data signature in training the AI/ML models.

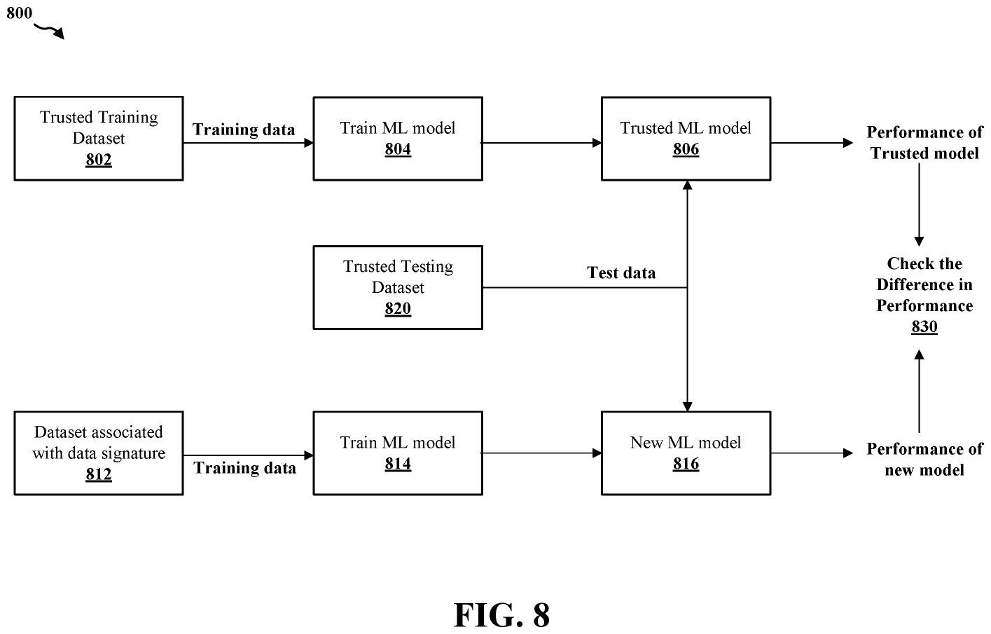

FIG. 8 is a diagram 800 of testing dataset associated with data signature with a trusted dataset. The diagram 800 shows how the network node or the core network may identify the data signature associated with the corrupted dataset including the perturbed data using a set of trusted dataset. Here, the set of trusted dataset may include a trusted training dataset 802 and a trusted testing dataset 820.

The network node or the core network may first filter the database to generate a first dataset 812 associated with a first data signature. The network node or the core network may test the first dataset 812 to identify whether the first data signature associated with the first dataset is associated with the corrupted dataset.

The network node or the core network may train an ML model, at 804, using the trusted training dataset 802 to generate the trusted ML model 806. The network node or the core network may train another ML model, at 814, using the first dataset 812 associated with the first data signature to generate the new ML model 816. As the trusted ML model 806 is trained using the known trusted training dataset 802, the network node or the core network may compare the performance of the trusted ML model 806 with the performance of the new ML model 816 trained with the first dataset 812 to test the legitimacy of the first dataset 812.

The network node or the core network may test the trusted ML model 806 and the new ML model 816 with the trusted testing dataset 820. Based on a first performance of the trusted ML model 806 from applying the trusted testing dataset 820, the network node or the core network may evaluate the performance of the new ML model 816 when applied with the trusted testing dataset 820. At 830, the network node or the core network may measure the difference in performance between the two AI/ML models, e.g., the trusted ML model 806 and the new ML model 816. If adding the first dataset 812 associated with the first data signature to the training set causes the resulting AI/ML model (e.g., the new ML model 816) to produce substantially more errors than the trusted AI/ML model, then the first dataset may be a corrupted dataset including the perturbed data. The network node or the core network may identify the first data signature to be associated with corrupted dataset and any dataset associated with the first data signature may be rejected.

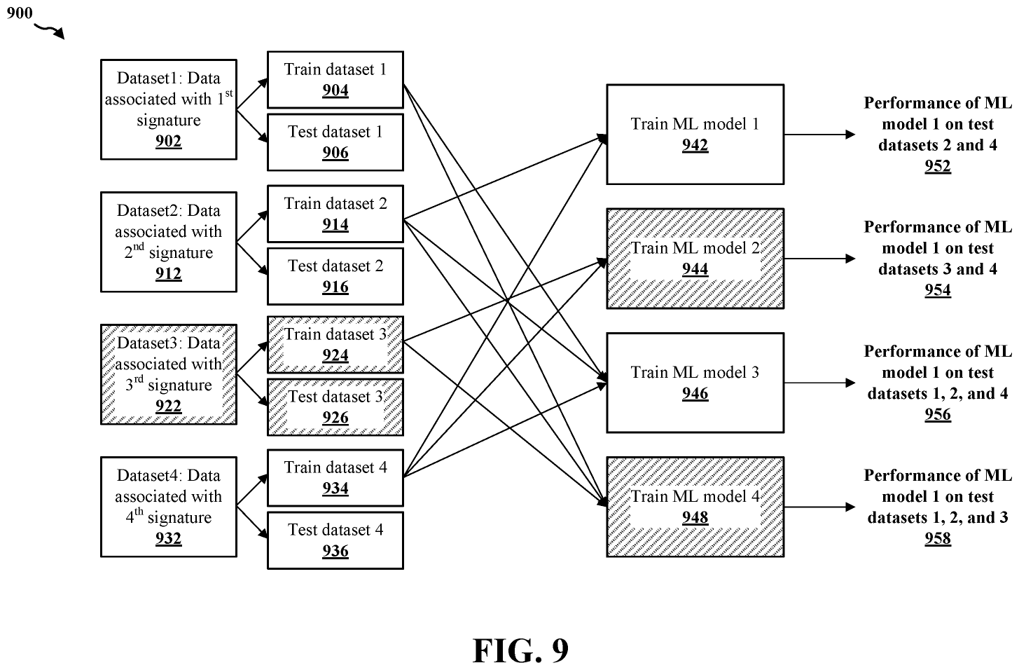

FIG. 9 is a diagram 900 of testing dataset associated with data signature without a trusted dataset. The diagram 800 shows how the network node or the core network may identify the data signature associated with the corrupted dataset including the perturbed data without using a trusted dataset.

First, the network node or the core network may group all data associated with a specific signature together into a specific dataset. In one example, the network node or the core network may utilized the data signature associated with the corresponding UE to group similar data into datasets. Accordingly, the network node or the core network may produce four datasets each associated with different data signatures, e.g., a first dataset 902 associated with a first data signature, a second dataset 912 associated with a second data signature, a third dataset 922 associated with a third data signature, and a fourth dataset 932 associated with a fourth data signature. Unknown to the network node or the core network, the third dataset 922 is a corrupted dataset including at least one perturbed data.

Second, the network node or the core network may divide the data from each dataset associated with the data signature into a training dataset and a testing dataset. That is, the network node or the core network may generate two datasets from each dataset associated with the data signature in to the training dataset for training ML models and the testing dataset for testing the trained ML models. Here, the first dataset 902 associated with the first data signature may be divided into a first training dataset 904 and a first testing dataset 906. The second dataset 912 associated with the second data signature may be divided into a second training dataset 914 and a second testing dataset 916. The third dataset 922 associated with the third data signature may be divided into a third training dataset 924 and a third testing dataset 926. Also, the fourth dataset 932 associated with the fourth data signature may be divided into a fourth training dataset 934 and a fourth testing dataset 936.

Third, the network node or the core network may train multiple AI/ML models using different combinations of the training datasets from the different datasets. The combination of candidate datasets included in training different AI/ML models may vary based on the implementation. The diagram 900 shows that a first AI/ML model 942 is trained using the second training dataset 914 and the fourth training dataset 934, a second AI/ML model 944 is trained using the third training dataset 924 and the fourth training dataset 934, a third AI/ML model 946 is trained using the first training dataset 904, the second training dataset 914, and the fourth training dataset 934, and a fourth AI/ML model 948 is trained using the first training dataset 904, the second training dataset 914, and the third training dataset 924.

Fourth, the network node or the core network may test each of the trained AI/ML model using the test datasets corresponding to the combination of training dataset used in training the AI/ML model. Here, the first AI/ML model 942 was trained using the second training dataset 914 and the fourth training dataset 934, the network node or the core network may test the first AI/ML model 942 using the second testing dataset 916 and the fourth testing dataset 936. The second AI/ML model 944 was trained using the third training dataset 924 and the fourth training dataset 934, the network node or the core network may test the second AI/ML model 944 using the third testing dataset 926 and the fourth testing dataset 936. The third AI/ML model 946 was trained using the first training dataset 904, the second training dataset 914, and the fourth training dataset 934, the network node or the core network may test the third AI/ML model 946 using the first testing dataset 906, the second testing dataset 916, and the fourth testing dataset 936. The fourth AI/ML model 948 was trained using the first training dataset 904, the second training dataset 914, and the third training dataset 924, the network node or the core network may test the fourth AI/ML model 948 using the first testing dataset 906, the second testing dataset 916, and the third testing dataset 926.

As the third dataset 922 is the corrupted dataset including the perturbed data, at least one of the third training dataset 924 or the third testing dataset 926 is corrupted dataset including the perturbed data. Accordingly, the performance of the AI/ML model trained using the third training dataset 924 using the third testing dataset 926 may show an increased number of errors or a decreased efficiency.

Accordingly, the network node or the core network may compare the first performance 952 of the first AI/ML model 942 on the second testing dataset 914 and the fourth testing dataset 936, the second performance 954 of the second AI/ML model 944 on the third testing dataset 926 and the fourth testing dataset 936, the third performance 956 of the third AI/ML model 946 on the first testing dataset 906, the second testing dataset 916, and the fourth testing dataset 936, and the fourth performance 958 of the fourth AI/ML model 948 on the first testing dataset 906, the second testing dataset 916, and the third testing dataset 926, and determine that the second performance 954 and the fourth performance 958 show performance drop (e.g., the increased number of errors or the decreased efficiency). Based on the outcome, the network node or the core network may identify that the second performance 954 and the fourth performance 958 share the third dataset 922, and determine that the third dataset 922 is the corrupted dataset including perturbed data. The network node or the core network may identify that the third data signature is associated with the corrupted dataset. The network node or the core network may filter out any data associated with the third data signature for the purpose of AI/ML model training.

According to some aspects of the current disclosure, the network node or the core network may monitor the performance gap between the multiple AI/ML models and observe for a candidate dataset that is commonly configured across the AI/ML models with degraded performance to identify the data signature associated with the corrupt dataset. The network node or the core network may monitor across the AI/ML models associated with different datasets based on the data signatures assigned to the data. As the data may be collected at different times and/or locations, the network node or the core network may identify the corrupted datasets using the data signature assigned to the collected data.

In one example, the UE signature may be used to identify the corrupted datasets. In other examples, a time/location/network node/device type data signatures may help the network node or the core network identify whether the dataset associated with a specific time/location/network node/device type is corrupted.

In some aspects, the network node or the core network may assign or instruct to assign data signature to the data and identify the data signature associated with the corrupted dataset. In one aspect, the network node or the core network may assign at least one data signature with a source of each dataset collected. In one example, the network node or the core network may configure the UE to associate the collected data samples/measurements/AI/ML model updates with a specific data signature. In another example, the network node or the core network may select the signature associated with the data (e.g., the location of data collection, the UE ID, the model and type of the sensor used in collecting the data, the time of collection, etc.).

In another aspect, at least one network entity (e.g., the network node, OAM or another core network entity) may request other network entities (e.g., neighboring network nodes) to share the signatures associated with the data samples/measurements/AI/ML model updates. In many scenarios, the data may be collected into one database by multiple network nodes to obtain a diverse dataset that accounts for different environmental conditions, and the AI/ML model may be trained at a single network entity (e.g., the network node or the OAM) using the database including data from multiple network nodes. Accordingly, the data collected from multiple network nodes may be shared across the network nodes or the OAM and the identification of data signature associated with the corrupted dataset may be more efficient if the data collected from the multiple network nodes or the core network may share the same data signature.

In another aspect, at least one network entity may label at least one dataset (e.g., the data samples, the data measurements, or the AI/ML model updates), associated with a specific data signature as unclean or untrusted and recommend (or instruct) that other network entities exclude these data samples from the AI/ML model training. For example, one AI/ML model training node (e.g., a network node or an OAM) may find that the data associated with a specific data signature (e.g., indicating that the data originated from a specific UE, was collected at a specific time or from a specific sensor) is consistently an outlier data. The network node may recommend other network entities to exclude these data samples associated with the specific data signature from training the AI/ML model and/or exclude the adversarial UE associated with the specific data signature from future data collection.

In another aspect, the network node or core network node such as the OAM may associate a legitimacy score (e.g., a trust score) or a cleanness score with the data associated with a specific signature and share the legitimacy score with other network entities. Here, the dataset associated with a relatively high legitimacy score may be used as the trusted dataset. In one example, the network node may compare the distribution and the properties of the data associated with a specific data signature with the distribution and properties of other trusted data having a high legitimacy score. In another example, the network node may generate a first dataset by filtering the data associated with a specific data signature, and use the generated first dataset in training an AI/ML model. Then, the network node or the core network may test the model performance on a trusted dataset for verification. If the performance is unexpectedly low, e.g., below a threshold then the network node may associate a low legitimacy (trust) or a low cleanness score to the specific data signature used to generate the first dataset. The network node may also notify other network entities with the identified trust score of the specific data signature.

In another aspect, the network node or the core network may associate the AL/ML model use case with the legitimacy (trust)/cleanness score of the data signature. That is, different datasets may be collected or generated for different purposes. For example, a UE may collect two sets of data for two different use cases (e.g., a first dataset for beam management and a second dataset for interference prediction). Then, if the network node or the core network suspect that the UE had perturbed the data in the second dataset for the interference prediction but may not be sure about the first dataset for the beam management. The network node may indicate that the data signature associated with the UE have a low trust score for the purpose of the interference prediction use-case, while sharing the second dataset for the beam management purpose with other core network entities. The training entity may independently determine whether to use the dataset for training the AI/ML model.

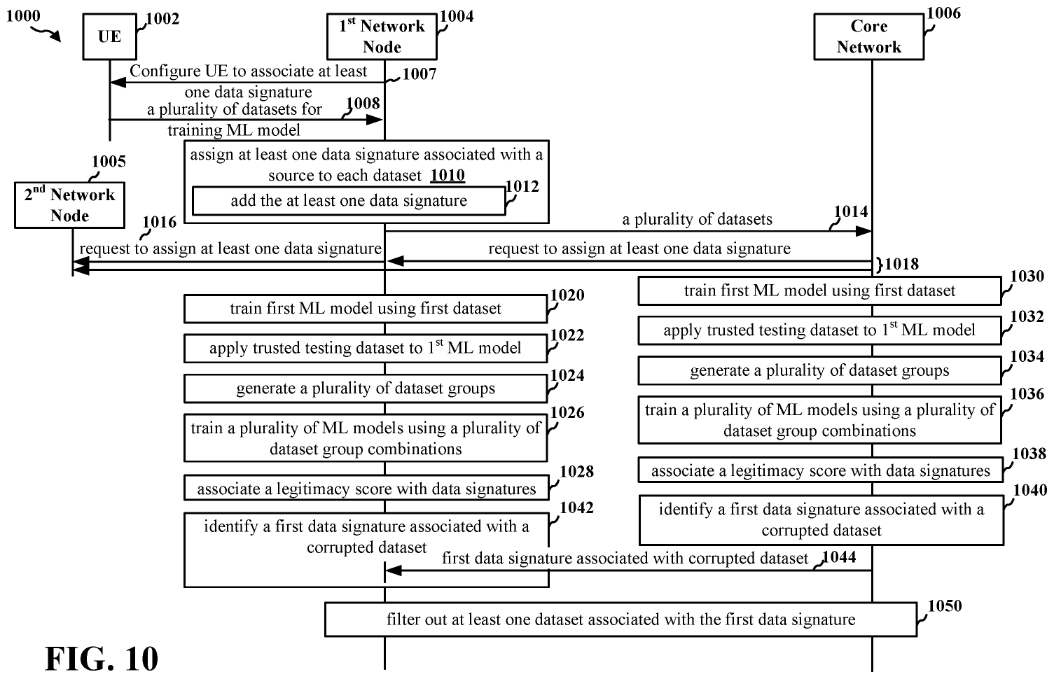

FIG. 10 is a call-flow diagram 1000 of a method of wireless communication. The call-flow diagram 1000 may include a UE 1002, a first network node 1004, a second network node 1005, and a core network 1006. The UE 1002 may collect a plurality of datasets for training ML models, and at least one of the UE 1002 or the network node (e.g., the first network node 1004 or the second network node 1005) may assign at least one data signature associated with a source of each dataset of the plurality of datasets. The first network node 1004 or the core network 1006 may verify whether certain dataset associated with a certain data signature is a corrupted dataset including at least one perturbed data, and identify that at least one data signature is associated with a corrupted dataset. The first network node 1004 or the core network 1006 may filter out the dataset associated with the at least one data signature associated with the corrupted dataset from training the AI/ML models.

At 1007, the first network node 1004 may configure, prior to obtaining the plurality of datasets, the corresponding UE to associate the at least one data signature with reported data from the corresponding UE. The UE 1002 may receive a configuration from a network node assigning at least one data signature to be reported with a dataset for an ML model.

At 1008, The UE 1002 may transmit one or more datasets for the ML model to the first network node 1004 and indicating the at least one data signature for the dataset. The first network node 1004 may obtain a plurality of datasets for training an ML model from at least one UE, each dataset including a set of metrics collected by a corresponding UE from the at least one UE.

In one aspect, based on the configuration assigning the at least one data signature to be reported with a dataset for an ML model transmitted at 1007, the plurality of datasets received from the UE 1002 may be assigned with the at least one data signature associated with the UE 1002 to each database. In another aspect, the plurality of datasets received from the UE 1002 may not be associated with a data signature yet, and the first network node 1004 may assign the at least one data signature associated with the source to each dataset at 1010.

At 1010, the first network node 1004 may assign at least one data signature associated with a source of each dataset of the plurality of datasets. Here, the data signature may indicate at least one of time or location of data collection, an ID of the corresponding UE associated with the dataset, an ID of the network node, a power class of the corresponding UE, a vendor of the corresponding UE, a component of the corresponding UE, age of the corresponding UE, or a model or a type of a sensor that collected the metric. 1010 may include 1012. At 1012, the first network node 1004 may add the at least one data signature to each obtained dataset.

At 1014, the first network node 1004 may transmit the plurality of datasets assigned with the at least one data signature to the core network 1006. The core network 1006 node may receive the plurality of datasets assigned with the at least one data signature from the first network node 1004. Here, the plurality of datasets may be assigned with the at least one data signature by the UE 1002 or by the first network node 1004 at 1010.

At 1016, the first network node 1004 may request at least one network node other than the first network node 1004 to assign the at least one data signature to datasets obtained by the at least one network node. Here, the first network node 1004 may request the second network node 1005 to assign the at least one data signature to datasets obtained by the second network node 1005. The second network node 1005 may receive request to assign the at least one data signature to datasets obtained by the second network node 1005.

At 1018, The core network 1006 node may instruct at least one network node to assign the at least one data signature to datasets obtained by the at least one network node. Here, the at least one network node may include the first network node 1004 and the second network node 1005. The first network node 1004 may receive an instruction to assign the at least one data signature to datasets obtained by the first network node 1004. The second network node 1005 may receive an instruction to assign the at least one data signature to datasets obtained by the second network node 1005.

In many scenarios, the plurality of datasets may be collected by multiple network nodes to obtain a diverse dataset that accounts for different environmental conditions, and the ML model may be trained at a single network entity (e.g., the first network node 1004, the second network node 1005, or the core network 1006) using the database including the plurality of datasets from multiple network nodes (e.g., the first network node 1004 and the second network node 1005). Accordingly, the data collected from the multiple network nodes may be shared across the network nodes or the core network 1006, and the identification of data signature associated with the corrupted dataset may be more efficient if the data collected from the multiple network nodes or the core network 1006 may share the same set of data signatures.

In some aspects, the first network node 1004 may be configured to identify the first data signature associated with a corrupted dataset. In one aspect, to verify the data, the first network node 1004 may test the performance of the data associated with the specific data signature on a previously trained ML model with trusted data. The first network node 1004 may compare the distribution and the statistical properties of the data associated with a specific signature with the distribution and statistical properties of other trusted data (e.g., generated under similar environments).

At 1020, the first network node 1004 may train a first ML model using the first dataset of the plurality of datasets. Here, the first network node 1004 may train the ML model using the first dataset (e.g., the first dataset 812) associated with the first data signature to generate the first ML model (e.g., the new ML model 816).

At 1022, the first network node 1004 may apply a trusted testing dataset to the first ML model and a trusted ML model, the trusted ML model being trained using a trusted training dataset. That is, the first network node 1004 may test the first ML model trained using the first dataset associated with the first data signature by applying the trusted testing data set to the first ML model and compare the performance with the trusted ML model trained using a trusted training dataset. If the first dataset is a corrupted dataset including at least one perturbed data, the performance of applying the trusted testing dataset may show an increased error or reduced efficiency, and the first network node 1004 may understand that the degraded performance is caused by the first dataset being the corrupted dataset. That is, based on determining that the performance difference between the first ML model and the trusted ML model being greater than a threshold value.

In another aspect, the first network node 1004 may verify the data associated with the specific data signature without the trusted data. The first network node 1004 may compare the distribution and the statistical properties of the data associated with different data signatures. Then the first network node 1004 may detect abnormalities in the data associated with a specific signature compared to the data associated with other signatures. Particularly, the first network node 1004 may divide (or group) the collected data based on the associated data signatures and train different ML models with different subsets of data signatures. Here, the ML models trained using a group of data including the perturbed data may be substantially lower than the other trained ML models. Therefore, the first network node 1004 may check the performance of the trailed ML models, and identify the perturbed data based on the performance of the ML models.

At 1024, the first network node 1004 may generate a plurality of dataset groups from the plurality of datasets based on the plurality of data signatures, each dataset groups being associated with one data signature of the plurality of data signatures. Each dataset group of the plurality of dataset groups may be different combinations of the plurality of candidate datasets.

In one aspect, the first network node 1004 may divide the data from each dataset associated with the data signature into a training dataset and a testing dataset. Here, the training dataset may be used to train the ML models, and the testing dataset may be used to test the trained ML models.

At 1026, the first network node 1004 may train a plurality of ML models using a plurality of dataset group combinations, each dataset group combination including more than one dataset groups of the plurality of dataset groups. That is, the first network node 1004 train multiple ML models using the training datasets of different dataset groups. Here, at least one dataset group may include a corrupted dataset including at least one perturbed data, and the ML model trained using the at least one dataset group including the corrupted dataset may have the increased error or the reduced efficiency.

At 1028, the first network node 1004 may associate a legitimacy score with one or more of a plurality of data signatures, where the first data signature may be identified as being associated with the corrupted dataset based on the first legitimacy score being lower than a threshold value.

In some aspects, the core network 1006 may be configured to identify the first data signature associated with a corrupted dataset. In one aspect, to verify the data, the core network 1006 may test the performance of the data associated with the specific data signature on a previously trained ML model with trusted data. The core network 1006 may compare the distribution and the statistical properties of the data associated with a specific signature with the distribution and statistical properties of other trusted data (e.g., generated under similar environments).

At 1030, the core network 1006 may train a first ML model using the first dataset of the plurality of datasets. Here, the core network 1006 may train the ML model using the first dataset (e.g., the first dataset 812) associated with the first data signature to generate the first ML model (e.g., the new ML model 816).

At 1032, the core network 1006 may apply a trusted testing dataset to the first ML model and a trusted ML model, the trusted ML model being trained using a trusted training dataset. That is, the core network 1006 may test the first ML model trained using the first dataset associated with the first data signature by applying the trusted testing data set to the first ML model and compare the performance with the trusted ML model trained using a trusted training dataset. If the first dataset is a corrupted dataset including at least one perturbed data, the performance of applying the trusted testing dataset may show an increased error or reduced efficiency, and the core network 1006 may understand that the degraded performance is caused by the first dataset being the corrupted dataset. That is, based on determining that the performance difference between the first ML model and the trusted ML model being greater than a threshold value.

In another aspect, the core network 1006 may verify the data associated with the specific data signature without the trusted data. The core network 1006 may compare the distribution and the statistical properties of the data associated with different data signatures. Then the core network 1006 may detect abnormalities in the data associated with a specific signature compared to the data associated with other signatures. Particularly, the core network 1006 may divide (or group) the collected data based on the associated data signatures and train different ML models with different subsets of data signatures. Here, the ML models trained using a group of data including the perturbed data may be substantially lower than the other trained ML models. Therefore, the core network 1006 may check the performance of the trailed ML models, and identify the perturbed data based on the performance of the ML models.

At 1034, the core network 1006 may generate a plurality of dataset groups from the plurality of datasets based on the plurality of data signatures, each dataset groups being associated with one data signature of the plurality of data signatures. Each dataset group of the plurality of dataset groups may be different combinations of the plurality of candidate datasets.

In one aspect, the core network 1006 may divide the data from each dataset associated with the data signature into a training dataset and a testing dataset. Here, the training dataset may be used to train the ML models, and the testing dataset may be used to test the trained ML models.

At 1036, the core network 1006 may train a plurality of ML models using a plurality of dataset group combinations, each dataset group combination including more than one dataset groups of the plurality of dataset groups. That is, the core network 1006 train multiple ML models using the training datasets of different dataset groups. Here, at least one dataset group may include a corrupted dataset including at least one perturbed data, and the ML model trained using the at least one dataset group including the corrupted dataset may have the increased error or the reduced efficiency.

At 1038, the core network 1006 may associate a legitimacy score with one or more of a plurality of data signatures, where the first data signature may be identified as being associated with the corrupted dataset based on the first legitimacy score being lower than a threshold value

At 1040, the core network 1006 may identify a first data signature associated with a corrupted dataset. In one aspect, based on 1030 and 1032, the first dataset may be identified as the corrupted dataset based on a performance difference between the first ML model and the trusted ML model being greater than a threshold value. In another aspect, based on 1030 and 1032, the first dataset may be identified as being associated with the corrupted dataset based on a distribution or statistical property of the first dataset differing by more than a threshold value from the trusted training dataset.

In another aspect, based on 1034 and 1036, the first data signature may be identified as being associated with the corrupted dataset based on a subset of ML models trained using a subset of dataset group combination including a first dataset group associated with the first data signature having lower performances than the plurality of ML models other than the subset of ML models.

At 1042 the first network node 1004 may identify a first data signature associated with a corrupted dataset. 1042 may include 1044. In one aspect, based on 1020 and 1022, the first dataset may be identified as the corrupted dataset based on a performance difference between the first ML model and the trusted ML model being greater than a threshold value. In another aspect, based on 1020 and 1022, the first dataset may be identified as being associated with the corrupted dataset based on a distribution or statistical property of the first dataset differing by more than a threshold value from the trusted training dataset.

In another aspect, based on 1024 and 1026, the first data signature may be identified as being associated with the corrupted dataset based on a subset of ML models trained using a subset of dataset group combination including a first dataset group associated with the first data signature having lower performances than the plurality of ML models other than the subset of ML models.

At 1044, the core network 1006 may transmit an indication that the first data signature is associated with the corrupted dataset. The first network node 1004 may receive, from the core network 1006, an indication that the first data signature may be associated with the corrupted dataset

AT 1050, the first network node 1004 may filter out at least one dataset associated with the first data signature from the plurality of datasets for training the ML model based on the first data signature being associated with the corrupted dataset. The core network 1006 node may filter out at least one dataset associated with the first data signature from the plurality of datasets for training the ML model based on the first data signature being associated with the corrupted dataset.

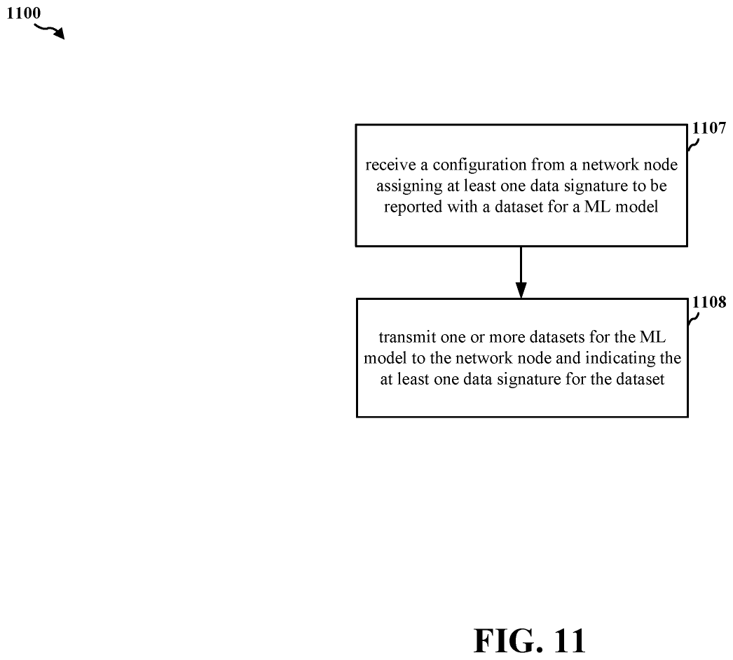

FIG. 11 is a flowchart 1100 of a method of wireless communication. The method may be performed by a UE (e.g., the UE 104/1002; the apparatus 1604). The UE may collect a plurality of datasets for training ML models, and assign at least one data signature associated with a source of each dataset of the plurality of datasets. The UE may send the collected plurality of datasets to the network node.

At 1107, the UE may receive a configuration from a network node assigning at least one data signature to be reported with a dataset for an ML model. For example, at 1007, the UE 1002 may receive a configuration from a network node assigning at least one data signature to be reported with a dataset for an ML model. Furthermore, 1107 may be performed by an ML data signature component 198.

At 1108, the UE may transmit one or more datasets for the ML model to the first network node 1004 and indicating the at least one data signature for the dataset. In one aspect, based on the configuration assigning the at least one data signature to be reported with a dataset for an ML model transmitted at 1007, the plurality of datasets received from the UE may be assigned with the at least one data signature associated with the UE to each database. For example, at 1008, the UE 1002 may transmit one or more datasets for the ML model to the first network node 1004 and indicating the at least one data signature for the dataset. Furthermore, 1108 may be performed by the ML data signature component 198.

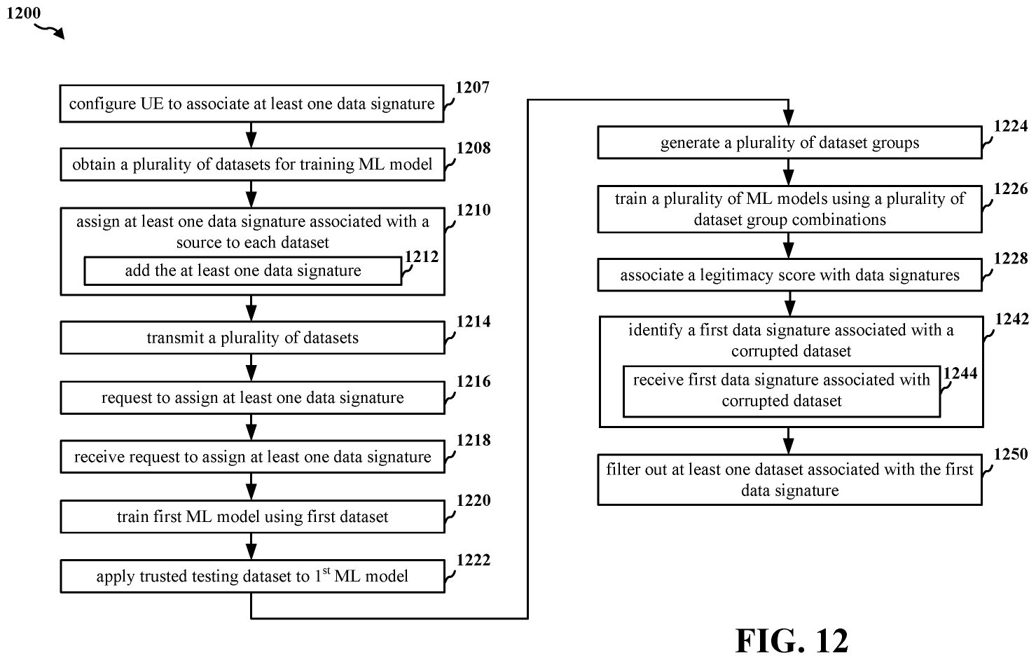

FIG. 12 is a flowchart 1200 of a method of wireless communication. The method may be performed by a network node (e.g., the base station 102; the first network node 1004; the network entity 1702). The network node may assign or instruct the at least one UE to assign at least one data signature associated with a source of each dataset of the plurality of datasets. The network node or the core network may collect the plurality of datasets, verify whether certain dataset associated with a certain data signature is a corrupted dataset including at least one perturbed data, and identify that at least one data signature is associated with a corrupted dataset. The network node or the core network may filter out the dataset associated with the at least one data signature associated with the corrupted dataset from training the AI/ML models.

At 1207, the network node may configure, prior to obtaining the plurality of datasets, the corresponding UE to associate the at least one data signature with reported data from the corresponding UE. For example, at 1007, the first network node 1004 may configure, prior to obtaining the plurality of datasets, the corresponding UE to associate the at least one data signature with reported data from the corresponding UE. Furthermore, 1207 may be performed by an ML training data component 199A.

At 1208, the network node may obtain a plurality of datasets for training an ML model from at least one UE, each dataset including a set of metrics collected by a corresponding UE from the at least one UE. In one aspect, based on the configuration assigning the at least one data signature to be reported with a dataset for an ML model transmitted at 1207, the plurality of datasets received from the UE may be assigned with the at least one data signature associated with the UE to each database. In another aspect, the plurality of datasets received from the UE may not be associated with a data signature yet, and the first network node may assign the at least one data signature associated with the source to each dataset at 1210. For example, at 1008, the first network node 1004 may obtain a plurality of datasets for training an ML model from at least one UE, each dataset including a set of metrics collected by a corresponding UE from the at least one UE. Furthermore, 1208 may be performed by the ML training data component 199A.

At 1210, the network node may assign at least one data signature associated with a source of each dataset of the plurality of datasets. Here, the data signature may indicate at least one of time or location of data collection, an ID of the corresponding UE associated with the dataset, an ID of the network node, a power class of the corresponding UE, a vendor of the corresponding UE, a component of the corresponding UE, age of the corresponding UE, or a model or a type of a sensor that collected the metric. 1210 may include 1212. At 1012, the first network node 1004 may add the at least one data signature to each obtained dataset. For example, at 1010, the first network node 1004 may assign at least one data signature associated with a source of each dataset of the plurality of datasets. Furthermore, 1210 may be performed by the ML training data component 199A.

At 1212, the network node may add the at least one data signature to each obtained data. For example, at 1012, the first network node 1004 may add the at least one data signature to each obtained data Furthermore, 1212 may be performed by the ML training data component 199A.

At 1214, the network node may transmit the plurality of datasets assigned with the at least one data signature to the core network. Here, the plurality of datasets may be assigned with the at least one data signature by the UE or by the first network node at 1210. For example, at 1014, the first network node 1004 may transmit the plurality of datasets assigned with the at least one data signature to the core network 1006. Furthermore, 1214 may be performed by the ML training data component 199A.

At 1216, the network node may request at least one network node other than the first network node 1004 to assign the at least one data signature to datasets obtained by the at least one network node. Here, the first network node 1004 may request the second network node 1005 to assign the at least one data signature to datasets obtained by the second network node 1005. For example, at 1016, the first network node 1004 may request at least one network node other than the first network node 1004 to assign the at least one data signature to datasets obtained by the at least one network node. Furthermore, 1216 may be performed by the ML training data component 199A.

At 1218, the network node may receive an instruction to assign the at least one data signature to datasets obtained by the network node. In many scenarios, the plurality of datasets may be collected by multiple network nodes to obtain a diverse dataset that accounts for different environmental conditions, and the ML model may be trained at a single network entity (e.g., the network node or the core network) using the database including the plurality of datasets from multiple network nodes Accordingly, the data collected from the multiple network nodes may be shared across the network nodes or the core network, and the identification of data signature associated with the corrupted dataset may be more efficient if the data collected from the multiple network nodes or the core network may share the same set of data signatures. For example, at 1018, the first network node 1004 may receive an instruction to assign the at least one data signature to datasets obtained by the first network node 1004. Furthermore, 1218 may be performed by the ML training data component 199A.

In some aspects, the network node may be configured to identify the first data signature associated with a corrupted dataset. In one aspect, to verify the data, the network node may test the performance of the data associated with the specific data signature on a previously trained ML model with trusted data. The network node may compare the distribution and the statistical properties of the data associated with a specific signature with the distribution and statistical properties of other trusted data (e.g., generated under similar environments).

At 1220, the network node may train a first ML model using the first dataset of the plurality of datasets. Here, the network node may train the ML model using the first dataset (e.g., the first dataset 812) associated with the first data signature to generate the first ML model (e.g., the new ML model 816). For example, at 1020, the first network node 1004 may train a first ML model using the first dataset of the plurality of datasets. Furthermore, 1220 may be performed by the ML training data component 199A.

At 1222, the network node may apply a trusted testing dataset to the first ML model and a trusted ML model, the trusted ML model being trained using a trusted training dataset. That is, the network node may test the first ML model trained using the first dataset associated with the first data signature by applying the trusted testing data set to the first ML model and compare the performance with the trusted ML model trained using a trusted training dataset. If the first dataset is a corrupted dataset including at least one perturbed data, the performance of applying the trusted testing dataset may show an increased error or reduced efficiency, and the first network node 1004 may understand that the degraded performance is caused by the first dataset being the corrupted dataset. That is, based on determining that the performance difference between the first ML model and the trusted ML model being greater than a threshold value. For example, at 1022, the first network node 1004 may apply a trusted testing dataset to the first ML model and a trusted ML model, the trusted ML model being trained using a trusted training dataset. Furthermore, 1222 may be performed by the ML training data component 199A.

In another aspect, the network node may verify the data associated with the specific data signature without the trusted data. The network node may compare the distribution and the statistical properties of the data associated with different data signatures. Then the network node may detect abnormalities in the data associated with a specific signature compared to the data associated with other signatures. Particularly, the network node may divide (or group) the collected data based on the associated data signatures and train different ML models with different subsets of data signatures. Here, the ML models trained using a group of data including the perturbed data may be substantially lower than the other trained ML models. Therefore, the network node may check the performance of the trailed ML models, and identify the perturbed data based on the performance of the ML models.

At 1224, the network node may generate a plurality of dataset groups from the plurality of datasets based on the plurality of data signatures, each dataset groups being associated with one data signature of the plurality of data signatures. Each dataset group of the plurality of dataset groups may be different combinations of the plurality of candidate datasets. In one aspect, the network node may divide the data from each dataset associated with the data signature into a training dataset and a testing dataset. Here, the training dataset may be used to train the ML models, and the testing dataset may be used to test the trained ML models. For example, at 1024, the first network node 1004 may generate a plurality of dataset groups from the plurality of datasets based on the plurality of data signatures, each dataset groups being associated with one data signature of the plurality of data signatures. Furthermore, 1224 may be performed by the ML training data component 199A.

At 1226, the network node may train a plurality of ML models using a plurality of dataset group combinations, each dataset group combination including more than one dataset groups of the plurality of dataset groups. That is, the network node train multiple ML models using the training datasets of different dataset groups. Here, at least one dataset group may include a corrupted dataset including at least one perturbed data, and the ML model trained using the at least one dataset group including the corrupted dataset may have the increased error or the reduced efficiency. For example, at 1026, the first network node 1004 may train a plurality of ML models using a plurality of dataset group combinations, each dataset group combination including more than one dataset groups of the plurality of dataset groups. Furthermore, 1226 may be performed by the ML training data component 199A.

At 1228, the network node may associate a legitimacy score with one or more of a plurality of data signatures, where the first data signature may be identified as being associated with the corrupted dataset based on the first legitimacy score being lower than a threshold value. For example, at 1028, the first network node 1004 may associate a legitimacy score with one or more of a plurality of data signatures. Furthermore, 1228 may be performed by the ML training data component 199A.

At 1242, the network node may identify a first data signature associated with a corrupted dataset. In one aspect, based on 1220 and 1222, the first dataset may be identified as the corrupted dataset based on a performance difference between the first ML model and the trusted ML model being greater than a threshold value. In another aspect, based on 1220 and 1222, the first dataset may be identified as being associated with the corrupted dataset based on a distribution or statistical property of the first dataset differing by more than a threshold value from the trusted training dataset. In another aspect, based on 1224 and 1226, the first data signature may be identified as being associated with the corrupted dataset based on a subset of ML models trained using a subset of dataset group combination including a first dataset group associated with the first data signature having lower performances than the plurality of ML models other than the subset of ML models. For example, at 1042, the first network node 1004 may identify a first data signature associated with a corrupted dataset. Furthermore, 1242 may be performed by the ML training data component 199A. 1042 may include 1044.

At 1244, the network node may receive, from the core network, an indication that the first data signature may be associated with the corrupted dataset. For example, at 1044, the first network node 1004 may receive, from the core network 1006, an indication that the first data signature may be associated with the corrupted dataset. Furthermore, 1244 may be performed by the ML training data component 199A.

At 1250, the network node may filter out at least one dataset associated with the first data signature from the plurality of datasets for training the ML model based on the first data signature being associated with the corrupted dataset. For example, at 1050, the first network node 1004 may filter out at least one dataset associated with the first data signature from the plurality of datasets for training the ML model based on the first data signature being associated with the corrupted dataset. Furthermore, 1250 may be performed by the ML training data component 199A.

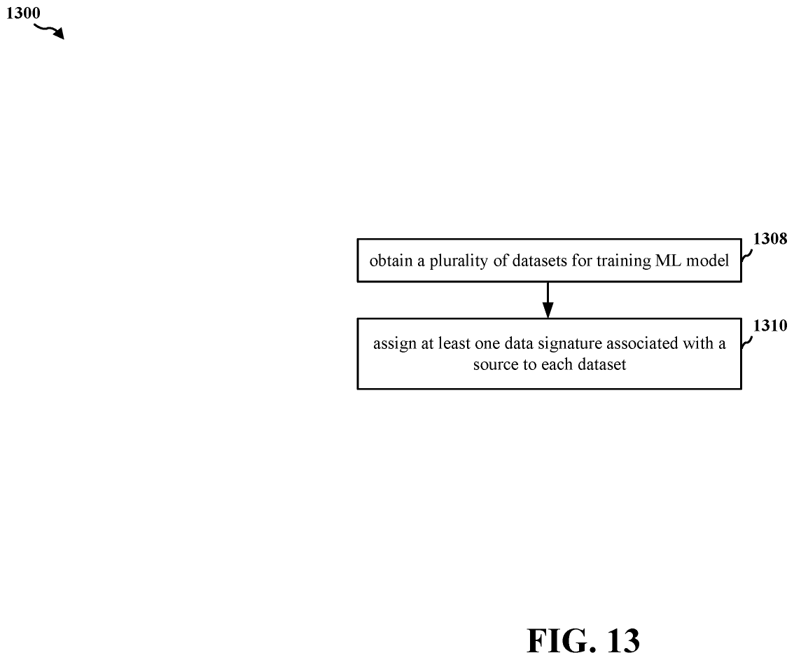

FIG. 13 is a flowchart 1300 of a method of wireless communication. The method may be performed by a network node (e.g., the base station 102; the first network node 1004; the network entity 1702). The network node may assign or instruct the at least one UE to assign at least one data signature associated with a source of each dataset of the plurality of datasets. The network node or the core network may collect the plurality of datasets, verify whether certain dataset associated with a certain data signature is a corrupted dataset including at least one perturbed data, and identify that at least one data signature is associated with a corrupted dataset. The network node or the core network may filter out the dataset associated with the at least one data signature associated with the corrupted dataset from training the AI/ML models.

At 1308, the network node may obtain a plurality of datasets for training an ML model from at least one UE, each dataset including a set of metrics collected by a corresponding UE from the at least one UE. In one aspect, based on the configuration assigning the at least one data signature to be reported with a dataset for an ML model transmitted at 1307, the plurality of datasets received from the UE may be assigned with the at least one data signature associated with the UE to each database. In another aspect, the plurality of datasets received from the UE may not be associated with a data signature yet, and the first network node may assign the at least one data signature associated with the source to each dataset at 1310. For example, at 1008, the first network node 1004 may obtain a plurality of datasets for training an ML model from at least one UE, each dataset including a set of metrics collected by a corresponding UE from the at least one UE. Furthermore, 1308 may be performed by the ML training data component 199A.

At 1310, the network node may assign at least one data signature associated with a source of each dataset of the plurality of datasets. Here, the data signature may indicate at least one of time or location of data collection, an ID of the corresponding UE associated with the dataset, an ID of the network node, a power class of the corresponding UE, a vendor of the corresponding UE, a component of the corresponding UE, age of the corresponding UE, or a model or a type of a sensor that collected the metric. 1310 may include 1312. At 1012, the first network node 1004 may add the at least one data signature to each obtained dataset. For example, at 1010, the first network node 1004 may assign at least one data signature associated with a source of each dataset of the plurality of datasets. Furthermore, 1310 may be performed by the ML training data component 199A.

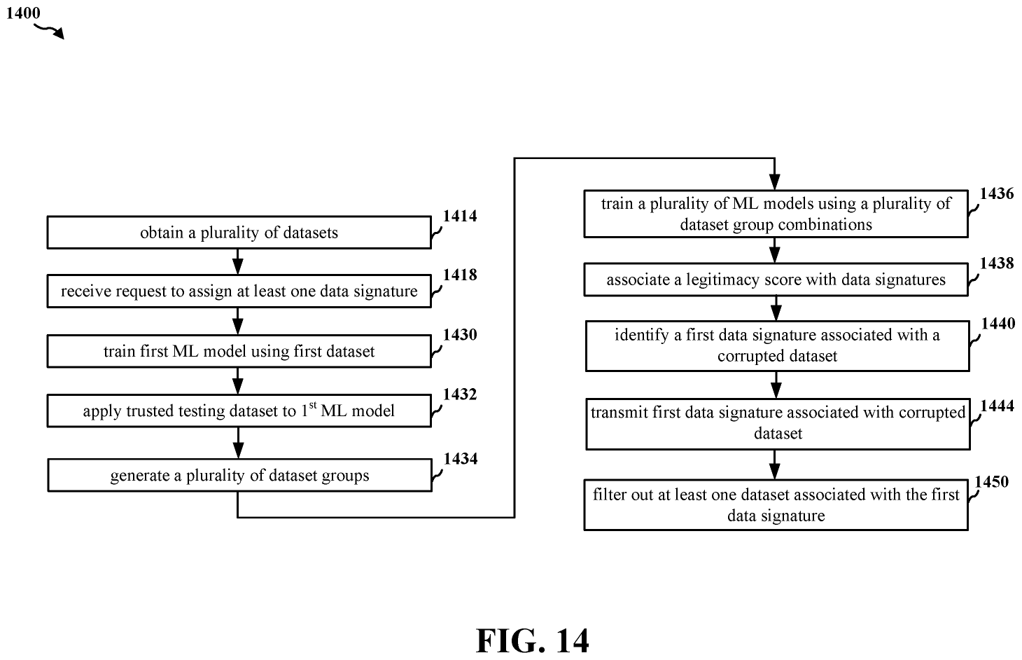

FIG. 14 is a flowchart 1400 of a method of wireless communication. The method may be performed by a core network (e.g., the base station 102; the core network 1006; the network entity 1860). The core network may collect the plurality of datasets, verify whether certain dataset associated with a certain data signature is a corrupted dataset including at least one perturbed data, and identify that at least one data signature is associated with a corrupted dataset. The core network may filter out the dataset associated with the at least one data signature associated with the corrupted dataset from training the AI/ML models.

At 1414, the network node may receive the plurality of datasets assigned with the at least one data signature from the network node. Here, the plurality of datasets may be assigned with the at least one data signature by the UE or by the network node. For example, at 1014, the core network 1006 may receive the plurality of datasets assigned with the at least one data signature from the first network node 1004. Furthermore, 1414 may be performed by an ML training data component 199B.

At 1418, the network node may instruct at least one network node to assign the at least one data signature to datasets obtained by the at least one network node. In many scenarios, the plurality of datasets may be collected by multiple network nodes to obtain a diverse dataset that accounts for different environmental conditions, and the ML model may be trained at a single network entity (e.g., the network node or the core network) using the database including the plurality of datasets from multiple network nodes. Accordingly, the data collected from the multiple network nodes may be shared across the network nodes or the core network, and the identification of data signature associated with the corrupted dataset may be more efficient if the data collected from the multiple network nodes or the core network may share the same set of data signatures. For example, at 1018, the core network 1006 may instruct at least one network node to assign the at least one data signature to datasets obtained by the at least one network node. Furthermore, 1418 may be performed by the ML training data component 199B.

In some aspects, the core network may be configured to identify the first data signature associated with a corrupted dataset. In one aspect, to verify the data, the core network may test the performance of the data associated with the specific data signature on a previously trained ML model with trusted data. The core network may compare the distribution and the statistical properties of the data associated with a specific signature with the distribution and statistical properties of other trusted data (e.g., generated under similar environments).

At 1430, the network node may train a first ML model using the first dataset of the plurality of datasets. Here, the core network may train the ML model using the first dataset (e.g., the first dataset 812) associated with the first data signature to generate the first ML model (e.g., the new ML model 816). For example, at 1030, the core network 1006 may train a first ML model using the first dataset of the plurality of datasets. Furthermore, 1430 may be performed by the ML training data component 199B.

At 1432, the network node may apply a trusted testing dataset to the first ML model and a trusted ML model, the trusted ML model being trained using a trusted training dataset. That is, the core network may test the first ML model trained using the first dataset associated with the first data signature by applying the trusted testing data set to the first ML model and compare the performance with the trusted ML model trained using a trusted training dataset. If the first dataset is a corrupted dataset including at least one perturbed data, the performance of applying the trusted testing dataset may show an increased error or reduced efficiency, and the core network 1006 may understand that the degraded performance is caused by the first dataset being the corrupted dataset. That is, based on determining that the performance difference between the first ML model and the trusted ML model being greater than a threshold value. For example, at 1032, the core network 1006 may apply a trusted testing dataset to the first ML model and a trusted ML model, the trusted ML model being trained using a trusted training dataset. Furthermore, 1432 may be performed by the ML training data component 199B.

In another aspect, the core network may verify the data associated with the specific data signature without the trusted data. The core network may compare the distribution and the statistical properties of the data associated with different data signatures. Then the core network may detect abnormalities in the data associated with a specific signature compared to the data associated with other signatures. Particularly, the core network may divide (or group) the collected data based on the associated data signatures and train different ML models with different subsets of data signatures. Here, the ML models trained using a group of data including the perturbed data may be substantially lower than the other trained ML models. Therefore, the core network may check the performance of the trailed ML models, and identify the perturbed data based on the performance of the ML models.

At 1434, the network node may generate a plurality of dataset groups from the plurality of datasets based on the plurality of data signatures, each dataset groups being associated with one data signature of the plurality of data signatures. Each dataset group of the plurality of dataset groups may be different combinations of the plurality of candidate datasets. In one aspect, the core network may divide the data from each dataset associated with the data signature into a training dataset and a testing dataset. Here, the training dataset may be used to train the ML models, and the testing dataset may be used to test the trained ML models. For example, at 1034, the core network 1006 may generate a plurality of dataset groups from the plurality of datasets based on the plurality of data signatures, each dataset groups being associated with one data signature of the plurality of data signatures. Furthermore, 1434 may be performed by the ML training data component 199B.

At 1436, the network node may train a plurality of ML models using a plurality of dataset group combinations, each dataset group combination including more than one dataset groups of the plurality of dataset groups. That is, the core network train multiple ML models using the training datasets of different dataset groups. Here, at least one dataset group may include a corrupted dataset including at least one perturbed data, and the ML model trained using the at least one dataset group including the corrupted dataset may have the increased error or the reduced efficiency. For example, at 1036, the core network 1006 may train a plurality of ML models using a plurality of dataset group combinations, each dataset group combination including more than one dataset groups of the plurality of dataset groups. Furthermore, 1436 may be performed by the ML training data component 199B.

At 1438, the network node may associate a legitimacy score with one or more of a plurality of data signatures, where the first data signature may be identified as being associated with the corrupted dataset based on the first legitimacy score being lower than a threshold value. For example, at 1038, the core network 1006 may associate a legitimacy score with one or more of a plurality of data signatures. Furthermore, 1438 may be performed by the ML training data component 199B.

At 1440, the network node may identify a first data signature associated with a corrupted dataset. In one aspect, based on 1430 and 1432, the first dataset may be identified as the corrupted dataset based on a performance difference between the first ML model and the trusted ML model being greater than a threshold value. In another aspect, based on 1430 and 1432, the first dataset may be identified as being associated with the corrupted dataset based on a distribution or statistical property of the first dataset differing by more than a threshold value from the trusted training dataset. In another aspect, based on 1434 and 1436, the first data signature may be identified as being associated with the corrupted dataset based on a subset of ML models trained using a subset of dataset group combination including a first dataset group associated with the first data signature having lower performances than the plurality of ML models other than the subset of ML models. For example, at 1040, the core network 1006 may identify a first data signature associated with a corrupted dataset. Furthermore, 1440 may be performed by the ML training data component 199B.

At 1444, the network node may transmit an indication that the first data signature is associated with the corrupted dataset. For example, at 1044, the core network 1006 may transmit an indication that the first data signature is associated with the corrupted dataset. Furthermore, 1444 may be performed by the ML training data component 199B.

At 1450, the network node may filter out at least one dataset associated with the first data signature from the plurality of datasets for training the ML model based on the first data signature being associated with the corrupted dataset. For example, at 1050, the core network 1006 may filter out at least one dataset associated with the first data signature from the plurality of datasets for training the ML model based on the first data signature being associated with the corrupted dataset. Furthermore, 1450 may be performed by the ML training data component 199B.

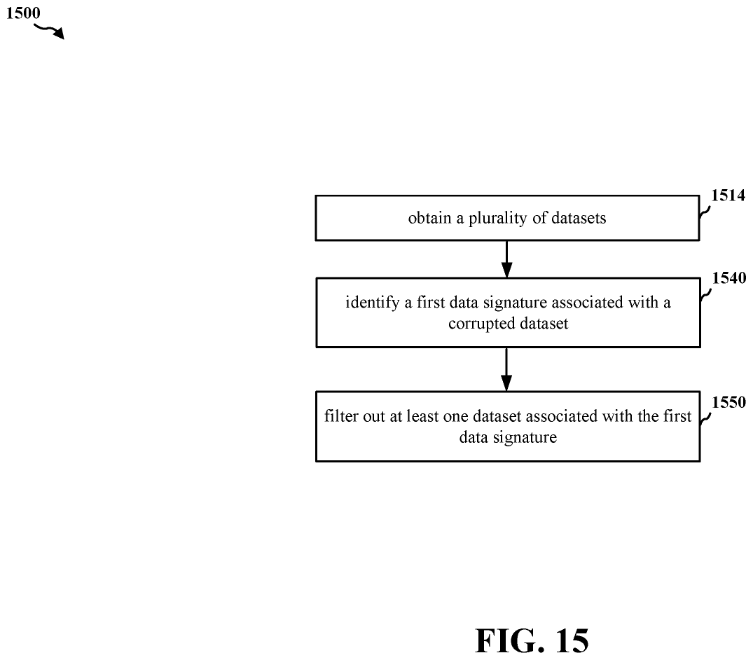

FIG. 15 is a flowchart 1500 of a method of wireless communication. The method may be performed by a core network (e.g., the base station 102; the core network 1006; the network entity 1860). The core network may collect the plurality of datasets, verify whether certain dataset associated with a certain data signature is a corrupted dataset including at least one perturbed data, and identify that at least one data signature is associated with a corrupted dataset. The core network may filter out the dataset associated with the at least one data signature associated with the corrupted dataset from training the Al/ML models.

At 1514, the network node may receive the plurality of datasets assigned with the at least one data signature from the network node. Here, the plurality of datasets may be assigned with the at least one data signature by the UE or by the network node. For example, at 1014, the core network 1006 may receive the plurality of datasets assigned with the at least one data signature from the first network node 1004. Furthermore, 1514 may be performed by an ML training data component 199B.

At 1540, the network node may identify a first data signature associated with a corrupted dataset. In one aspect, based on 1530 and 1532, the first dataset may be identified as the corrupted dataset based on a performance difference between the first ML model and the trusted ML model being greater than a threshold value. In another aspect, based on 1530 and 1532, the first dataset may be identified as being associated with the corrupted dataset based on a distribution or statistical property of the first dataset differing by more than a threshold value from the trusted training dataset. In another aspect, based on 1534 and 1536, the first data signature may be identified as being associated with the corrupted dataset based on a subset of ML models trained using a subset of dataset group combination including a first dataset group associated with the first data signature having lower performances than the plurality of ML models other than the subset of ML models. For example, at 1040, the core network 1006 may identify a first data signature associated with a corrupted dataset. Furthermore, 1540 may be performed by the ML training data component 199B.

At 1550, the network node may filter out at least one dataset associated with the first data signature from the plurality of datasets for training the ML model based on the first data signature being associated with the corrupted dataset. For example, at 1050, the core network 1006 may filter out at least one dataset associated with the first data signature from the plurality of datasets for training the ML model based on the first data signature being associated with the corrupted dataset. Furthermore, 1550 may be performed by the ML training data component 199B.

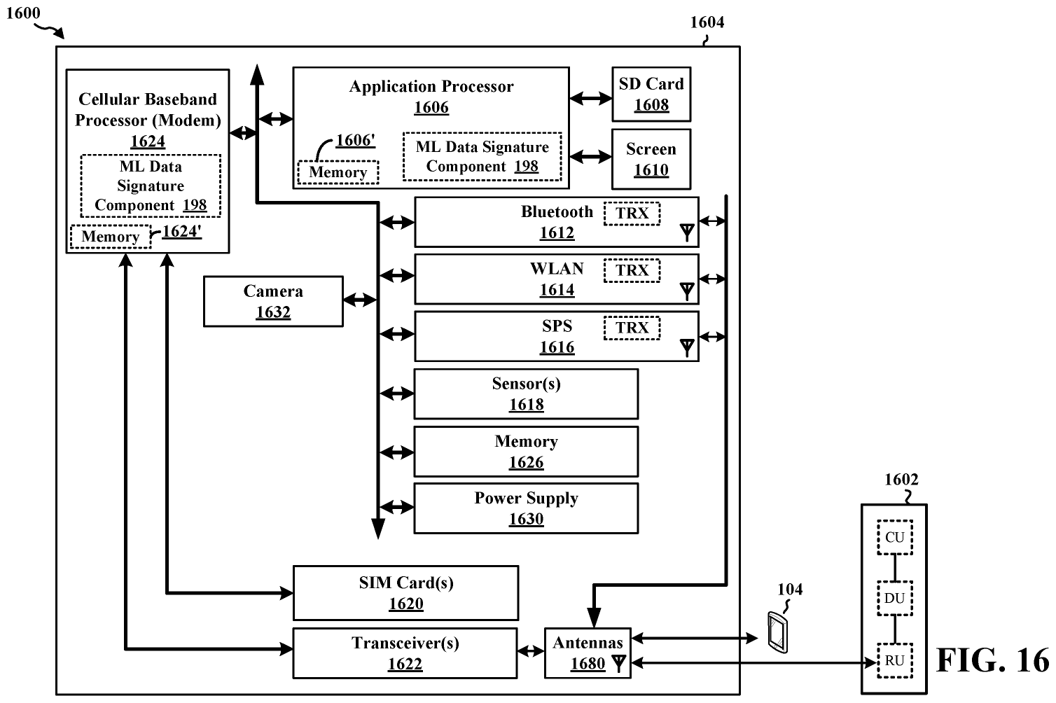

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the ML data signature component 198 is configured to receive a configuration from a network node assigning at least one data signature to be reported with a dataset for an ML model, and transmit one or more datasets for the ML model to the network node and indicating the at least one data signature for the dataset. The ML data signature component 198 may be further configured to perform any of the aspects described in connection with FIG. 11 and/or the aspects performed by the UE 1002 in FIG. 10. The ML data signature component 198 may be within the cellular baseband processor 1624, the application processor 1606, or both the cellular baseband processor 1624 and the application processor 1606. The ML data signature component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving a configuration from a network node assigning at least one data signature to be reported with a dataset for a ML model, and means for transmitting one or more datasets for the ML model to the network node and indicating the at least one data signature for the dataset. In one configuration, the at least one data signature includes at least one of time or location of data collection, a first ID of the UE, a second ID of the network node associated with the UE, a power class of the UE, a vendor of the UE, a component of the UE, age of the UE, or a model or a type of a sensor that collects data. The apparatus may further include means for performing any of the aspects described in connection with FIG. 11 and/or the aspects performed by the UE in FIG. 10. The means may be the ML data signature component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

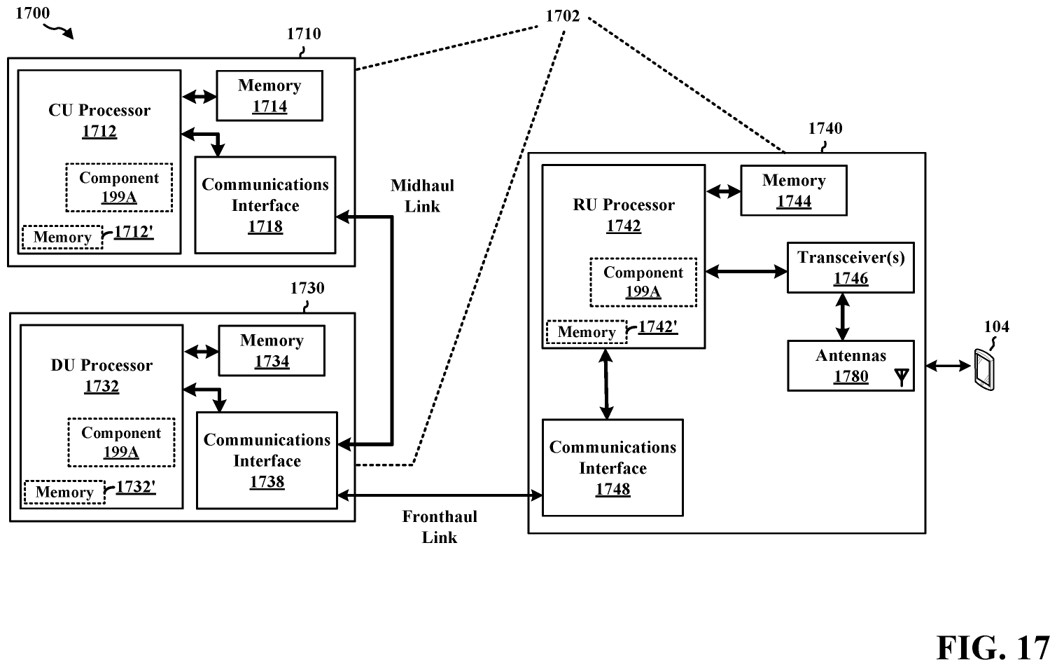

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the ML training data component 199A, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the ML training data component 199A is configured to obtain a plurality of datasets for training an ML model from at least one UE, each dataset including a set of metrics collected by a corresponding UE from the at least one UE, and assign at least one data signature associated with a source of each dataset of the plurality of datasets. The ML training data component 199A may be further configured to perform any of the aspects described in connection with FIGS. 12 and 13 and/or the aspects performed by the first network node 1004 in FIG. 10. The ML training data component 199A may be within one or more processors of one or more of the CU 1710, DU 1730, and the RU 1740. The ML training data component 199A may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for obtaining a plurality of datasets for training a ML model from at least one UE, each dataset including a set of metrics collected by a corresponding UE from the at least one UE, and means for assigning at least one data signature associated with a source of each dataset of the plurality of datasets. In one configuration, the network entity 1702 further includes means for configuring, prior to obtaining the plurality of datasets, the corresponding UE to associate the at least one data signature with reported data from the corresponding UE. In one configuration, the means for assigning the at least one data signature associated with the source of each dataset is further configured to add the at least one data signature to each obtained dataset. In one configuration, the network entity 1702 further includes means for requesting at least one network node other than the network node to assign the at least one data signature to datasets obtained by the at least one network node. In one configuration, each of the at least one data signature indicates at least one of time or location of data collection, a first ID of the corresponding UE associated with a corresponding dataset, a second ID of the network node, a power class of the corresponding UE, a vendor of the corresponding UE, a component of the corresponding UE, age of the corresponding UE, or a model or a type of a sensor that collected a metric. In one configuration, the network entity 1702 further includes means for identifying a first data signature associated with a corrupted dataset, and means for filtering out at least one dataset associated with the first data signature from the plurality of datasets for training the ML model based on the first data signature being associated with the corrupted dataset. In one configuration, the means for identifying the first data signature associated with the corrupted dataset is further configured to receive, from a core network, an indication that the first data signature is associated with the corrupted dataset. In one configuration, the network entity 1702 further includes means for training a first ML model using a first dataset of the plurality of datasets, and means for applying a trusted testing dataset to the first ML model and a trusted ML model, the trusted ML model being trained using a trusted training dataset, where the first dataset is identified as the corrupted dataset based on a performance difference between the first ML model and the trusted ML model being greater than a first threshold value. In one configuration, the first dataset is identified as being associated with the corrupted dataset based on a distribution or statistical property of the first dataset differing by more than a second threshold value from the trusted training dataset. In one configuration, the network entity 1702 further includes means for generating a plurality of dataset groups from the plurality of datasets based on a plurality of data signatures, each dataset groups being associated with one data signature of the plurality of data signatures, and means for training a plurality of ML models using a plurality of dataset group combinations, each dataset group combination including more than one dataset groups of the plurality of dataset groups, where the first data signature is identified as being associated with the corrupted dataset based on a first subset of ML models trained using a second subset of dataset group combination including a first dataset group associated with the first data signature having lower performances than the plurality of ML models other than the first subset of the ML models. In one configuration, the network entity 1702 further includes means for associating a legitimacy score with one or more of a plurality of data signatures, where the first data signature is identified as being associated with the corrupted dataset based on the legitimacy score being lower than a threshold value. In one configuration, the network entity 1702 further includes means for filtering at least one dataset associated with the first data signature from the plurality of datasets for training the ML model based on a use case of the ML model. In one configuration, the network entity 1702 further includes means for transmitting the plurality of datasets assigned with the at least one data signature to a core network. The apparatus may further include means for performing any of the aspects described in connection with FIGS. 12 and 13 and/or the aspects performed by the first network node 1004 in FIG. 10. The means may be the ML training data component 199A of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

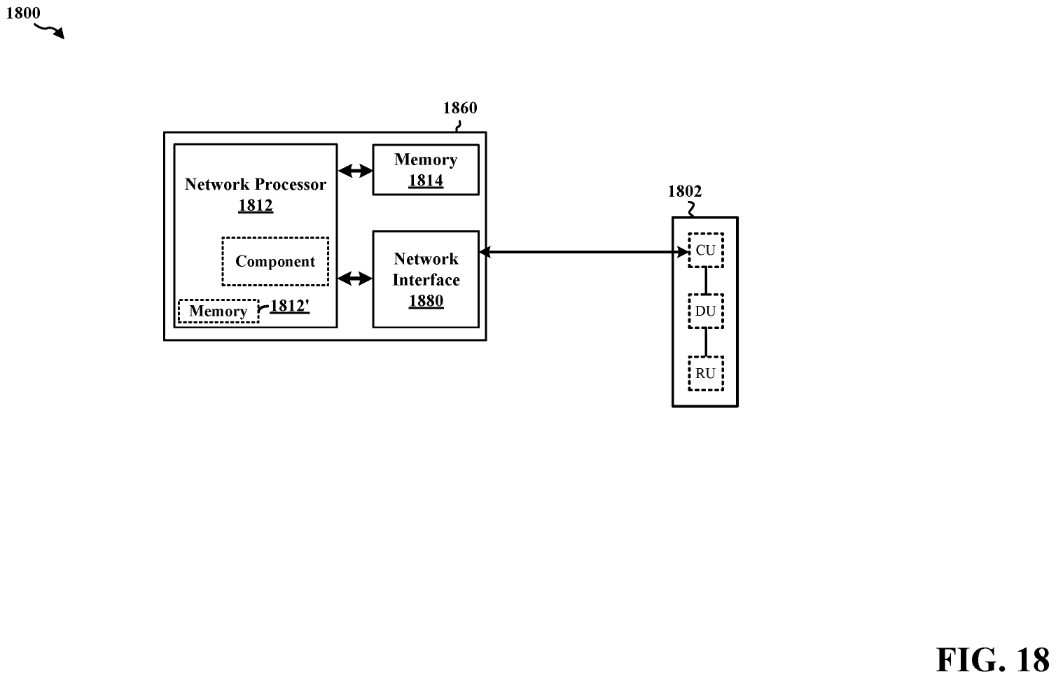

FIG. 18 is a diagram 1800 illustrating an example of a hardware implementation for a network entity 1860. In one example, the network entity 1860 may be within the core network 120. The network entity 1860 may include a network processor 1812. The network processor 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The processor 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the ML training data component 199B is configured to obtain a plurality of datasets for training an ML model from at least one network node, each dataset being assigned with a corresponding data signature and each data set including a set of metrics collected by a UE served by the at least one network node, identify a first data signature associated with a corrupted dataset, and filter out at least one dataset associated with the first data signature from the plurality of datasets for training the ML model based on the first data signature being associated with the corrupted dataset. The ML training data component 199B may be further configured to perform any of the aspects described in connection with FIGS. 14 and 15 and/or the aspects performed by the core network 1006 in FIG. 10. The ML training data component 199B may be within the processor 1812. The ML training data component 199B may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1860 may include a variety of components configured for various functions. In one configuration, the network entity 1860 includes means for obtaining a plurality of datasets for training a ML model from at least one network node, each dataset being assigned with a corresponding data signature and each dataset including a set of metrics collected by a UE served by the at least one network node, means for identifying a first data signature associated with a corrupted dataset, and means for filtering out at least one dataset associated with the first data signature from the plurality of datasets for training the ML model based on the first data signature being associated with the corrupted dataset. In one configuration, the network entity 1860 further includes means for instructing the at least one network node to assign the corresponding data signature to datasets obtained by the at least one network node. In one configuration, the corresponding data signature includes at least one of time or location of data collection, a first ID of a corresponding UE that is a source of a corresponding dataset, a second ID of a network node associated with the corresponding UE, a power class of the corresponding UE, a vendor of the corresponding UE, a component of the corresponding UE, age of the corresponding UE, or a model or a type of a sensor that collected a metric. In one configuration, the network entity 1860 further includes means for training a first ML model using a first dataset of the plurality of datasets, and means for applying a trusted testing dataset to the first ML model and a trusted ML model, the trusted ML model being trained using a trusted training dataset, where the first dataset is identified as the corrupted dataset based on a performance difference between the first ML model and the trusted ML model being greater than a first threshold value. In one configuration, the first dataset is identified as being associated with the corrupted dataset based on a distribution or statistical property of the first dataset differing by more than a second threshold value from the trusted training dataset. In one configuration, the network entity 1860 further includes means for generating a plurality of dataset groups from the plurality of datasets based on a plurality of data signatures, each dataset groups being associated with one data signature of the plurality of data signatures, and means for training a plurality of ML models using a plurality of dataset group combinations, each dataset group combination including more than one dataset groups of the plurality of dataset groups, where the first data signature is identified as being associated with the corrupted dataset based on a first subset of ML models trained using a second subset of dataset group combination including a first dataset group associated with the first data signature having lower performances than the plurality of ML models other than the first subset of the ML models. In one configuration, one or more of a plurality of data signatures are associated with legitimacy scores, and the first data signature is identified as being associated with the corrupted dataset based on a legitimacy score being lower than a threshold value. In one configuration, the corrupted dataset associated with the first data signature is filtered out from the plurality of datasets for training the ML model based on a use case of the ML model. In one configuration, the network entity 1860 further includes means for instructing the at least one network node to filter out the corrupted dataset associated with the first data signature. The apparatus may further include means for performing any of the aspects described in connection with FIGS. 14 and 15 and/or the aspects performed by the core network 1006 in FIG. 10. The means may be the ML training data component 199B of the network entity 1860 configured to perform the functions recited by the means.

In some aspects of the current disclosure, at least one network node or a core network may obtain a plurality of datasets for training a ML model, each dataset including a set of metrics collected by a corresponding UE from the at least one UE, and assign at least one data signature associated with a source of each dataset of the plurality of datasets. The network node or the core network may identify a first data signature associated with a corrupted dataset, and filter out at least one dataset associated with the first data signature from the plurality of datasets for training the ML model based on the first data signature being associated with the corrupted dataset.

In one aspect, the network node may obtain a plurality of datasets for training a ML model from at least one UE, each dataset including a set of metrics collected by a corresponding UE from the at least one UE, and assign at least one data signature associated with a source of each dataset of the plurality of datasets.

In another aspect, the core network may obtain a plurality of datasets for training a ML model from at least one network node, each dataset being assigned with a corresponding data signature and each data set including a set of metrics collected by a UE served by the at least one network node, identify a first data signature associated with a corrupted dataset, and filter out at least one dataset associated with the first data signature from the plurality of datasets for training the ML model based on the first data signature being associated with the corrupted dataset.

In another aspect, the UE may receive a configuration from a network node assigning at least one data signature to be reported with a dataset for a ML model, and transmit one or more datasets for the ML model to the network node and indicating the at least one data signature for the dataset.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node, including obtaining a plurality of datasets for training a ML model from at least one UE, each dataset including a set of metrics collected by a corresponding UE from the at least one UE and assigning at least one data signature associated with a source of each dataset of the plurality of datasets.

Aspect 2 is the method of aspect 1, further including configuring, prior to obtaining the plurality of datasets, the corresponding UE to associate the at least one data signature with reported data from the corresponding UE.

Aspect 3 is the method of any of aspects 1 and 2, where assigning the at least one data signature associated with the source of each dataset further includes adding the at least one data signature to each obtained dataset.

Aspect 4 is the method of any of aspects 1 to 3, further including requesting at least one network node other than the network node to assign the at least one data signature to datasets obtained by the at least one network node.

Aspect 5 is the method of any of aspects 1 to 4, where each of the at least one data signature indicates at least one of time or location of data collection, a first ID of the corresponding UE associated with a corresponding dataset, a second ID of the network node, a power class of the corresponding UE, a vendor of the corresponding UE, a component of the corresponding UE, age of the corresponding UE, or a model or a type of a sensor that collected a metric.

Aspect 6 is the method of any of aspects 1 to 5, further including identifying a first data signature associated with a corrupted dataset, and filtering out at least one dataset associated with the first data signature from the plurality of datasets for training the ML model based on the first data signature being associated with the corrupted dataset.

Aspect 7 is the method of aspect 6, where identifying the first data signature associated with the corrupted dataset further includes receiving, from a core network, an indication that the first data signature is associated with the corrupted dataset.

Aspect 8 is the method of any of aspects 6 and 7, further including training a first ML model using a first dataset of the plurality of datasets, and applying a trusted testing dataset to the first ML model and a trusted ML model, the trusted ML model being trained using a trusted training dataset, where the first dataset is identified as the corrupted dataset based on a performance difference between the first ML model and the trusted ML model being greater than a first threshold value.

Aspect 9 is the method of aspect 8, where the first dataset is identified as being associated with the corrupted dataset based on a distribution or statistical property of the first dataset differing by more than a second threshold value from the trusted training dataset.

Aspect 10 is the method of any of aspects 6 to 9, further including generating a plurality of dataset groups from the plurality of datasets based on a plurality of data signatures, each dataset groups being associated with one data signature of the plurality of data signatures, and training a plurality of ML models using a plurality of dataset group combinations, each dataset group combination including more than one dataset groups of the plurality of dataset groups, where the first data signature is identified as being associated with the corrupted dataset based on a first subset of ML models trained using a second subset of dataset group combination including a first dataset group associated with the first data signature having lower performances than the plurality of ML models other than the first subset of the ML models.

Aspect 11 is the method of any of aspects 6 to 10, further including associating a legitimacy score with one or more of a plurality of data signatures, where the first data signature is identified as being associated with the corrupted dataset based on the legitimacy score being lower than a threshold value.

Aspect 12 is the method of any of aspects 6 to 11, further including filtering at least one dataset associated with the first data signature from the plurality of datasets for training the ML model based on a use case of the ML model.

Aspect 13 is the method of any of aspects 1 to 12, further including transmitting the plurality of datasets assigned with the at least one data signature to a core network.

Aspect 14 is an apparatus for wireless communication including at least one processor coupled to a memory and configured to implement any of aspects 1 to 13, further including a transceiver coupled to the at least one processor.

Aspect 15 is an apparatus for wireless communication including means for implementing any of aspects 1 to 13.

Aspect 16 is a non-transitory computer-readable medium storing computer executable code, where the code when executed by a processor causes the processor to implement any of aspects 1 to 13.

Aspect 17 is a method of wireless communication at a core network, including obtaining a plurality of datasets for training a ML model from at least one network node, each dataset being assigned with a corresponding data signature and each dataset including a set of metrics collected by a UE served by the at least one network node, identifying a first data signature associated with a corrupted dataset, and filtering out at least one dataset associated with the first data signature from the plurality of datasets for training the ML model based on the first data signature being associated with the corrupted dataset.

Aspect 18 is the method of aspect 17, further including instructing the at least one network node to assign the corresponding data signature to datasets obtained by the at least one network node.

Aspect 19 is the method of any of aspects 17 and 18, where the corresponding data signature includes at least one of time or location of data collection, a first ID of a corresponding UE that is a source of a corresponding dataset, a second ID of a network node associated with the corresponding UE, a power class of the corresponding UE, a vendor of the corresponding UE, a component of the corresponding UE, age of the corresponding UE, or a model or a type of a sensor that collected a metric.

Aspect 20 is the method of any of aspects 17 to 19, further including training a first ML model using a first dataset of the plurality of datasets, and applying a trusted testing dataset to the first ML model and a trusted ML model, the trusted ML model being trained using a trusted training dataset, where the first dataset is identified as the corrupted dataset based on a performance difference between the first ML model and the trusted ML model being greater than a first threshold value.

Aspect 21 is the method of aspect 20, where the first dataset is identified as being associated with the corrupted dataset based on a distribution or statistical property of the first dataset differing by more than a second threshold value from the trusted training dataset.

Aspect 22 is the method of any of aspects 17 to 21, further including generating a plurality of dataset groups from the plurality of datasets based on a plurality of data signatures, each dataset groups being associated with one data signature of the plurality of data signatures, and training a plurality of ML models using a plurality of dataset group combinations, each dataset group combination including more than one dataset groups of the plurality of dataset groups, where the first data signature is identified as being associated with the corrupted dataset based on a first subset of ML models trained using a second subset of dataset group combination including a first dataset group associated with the first data signature having lower performances than the plurality of ML models other than the first subset of the ML models.

Aspect 23 is the method of any of aspects 17 to 22, where one or more of a plurality of data signatures are associated with legitimacy scores, and the first data signature is identified as being associated with the corrupted dataset based on a legitimacy score being lower than a threshold value.

Aspect 24 is the method of any of aspects 17 to 23, where the corrupted dataset associated with the first data signature is filtered out from the plurality of datasets for training the ML model based on a use case of the ML model.

Aspect 25 is the method of any of aspects 17 to 24, further including instructing the at least one network node to filter out the corrupted dataset associated with the first data signature.

Aspect 26 is an apparatus for wireless communication including at least one processor coupled to a memory and configured to implement any of aspects 17 to 25, further including a transceiver coupled to the at least one processor.

Aspect 27 is an apparatus for wireless communication including means for implementing any of aspects 17 to 25.

Aspect 28 is a non-transitory computer-readable medium storing computer executable code, where the code when executed by a processor causes the processor to implement any of aspects 17 to 25.

Aspect 29 is a method of wireless communication at a UE, including receiving a configuration from a network node assigning at least one data signature to be reported with a dataset for a ML model, and transmitting one or more datasets for the ML model to the network node and indicating the at least one data signature for the dataset.

Aspect 30 is the method of aspect 29, where the at least one data signature includes at least one of time or location of data collection, a first ID of the UE, a second ID of the network node associated with the UE, a power class of the UE, a vendor of the UE, a component of the UE, age of the UE, or a model or a type of a sensor that collects data.

Aspect 31 is an apparatus for wireless communication including at least one processor coupled to a memory and configured to implement any of aspects 29 and 30, further including a transceiver coupled to the at least one processor.

Aspect 32 is an apparatus for wireless communication including means for implementing any of aspects 29 and 30.

Aspect 33 is a non-transitory computer-readable medium storing computer executable code, where the code when executed by a processor causes the processor to implement any of aspects 29 and 30.

What is claimed is:

1. An apparatus for a wireless communication at a network node, comprising:
a memory; and
at least one processor coupled to the memory and, based at least in part on information stored in the memory, the at least one processor is configured to:
obtain a plurality of datasets for training a machine learning (ML) model from at least one user equipment (UE), each dataset including a set of metrics collected by a corresponding UE from the at least one UE; and
assign at least one data signature associated with a source of each dataset of the plurality of datasets.

2. The apparatus of claim 1, wherein the at least one processor is further configured to:
configure, prior to obtaining the plurality of datasets, the corresponding UE to associate the at least one data signature with reported data from the corresponding UE.

3. The apparatus of claim 1, wherein to assign the at least one data signature associated with the source of each dataset, the at least one processor is configured to:
add the at least one data signature to each obtained dataset.

4. The apparatus of claim 1, wherein the at least one processor is further configured to:
request at least one network node other than the network node to assign the at least one data signature to datasets obtained by the at least one network node.

5. The apparatus of claim 1, wherein each of the at least one data signature indicates at least one of:
time or location of data collection,
a first identifier (ID) of the corresponding UE associated with a corresponding dataset,
a second ID of the network node,
a power class of the corresponding UE,
a vendor of the corresponding UE,
a component of the corresponding UE,
age of the corresponding UE, or
a model or a type of a sensor that collected a metric.

6. The apparatus of claim 1, wherein the at least one processor is further configured to:
identify a first data signature associated with a corrupted dataset; and
filter out at least one dataset associated with the first data signature from the plurality of datasets for training the ML model based on the first data signature being associated with the corrupted dataset.

7. The apparatus of claim 6, wherein to identify the first data signature associated with the corrupted dataset, the at least one processor is further configured to:
receive, from a core network, an indication that the first data signature is associated with the corrupted dataset.

8. The apparatus of claim 6, wherein the at least one processor is further configured to:
train a first ML model using a first dataset of the plurality of datasets; and
apply a trusted testing dataset to the first ML model and a trusted ML model, the trusted ML model being trained using a trusted training dataset,
wherein the first dataset is identified as the corrupted dataset based on a performance difference between the first ML model and the trusted ML model being greater than a first threshold value.

9. The apparatus of claim 8, wherein the first dataset is identified as being associated with the corrupted dataset based on a distribution or statistical property of the first dataset differing by more than a second threshold value from the trusted training dataset.

10. The apparatus of claim 6, wherein the at least one processor is further configured to:
generate a plurality of dataset groups from the plurality of datasets based on a plurality of data signatures, each dataset groups being associated with one data signature of the plurality of data signatures; and
train a plurality of ML models using a plurality of dataset group combinations, each dataset group combination including more than one dataset groups of the plurality of dataset groups,
wherein the first data signature is identified as being associated with the corrupted dataset based on a first subset of ML models trained using a second subset of dataset group combination including a first dataset group associated with the first data signature having lower performances than the plurality of ML models other than the first subset of the ML models.

11. The apparatus of claim 6, wherein the at least one processor is further configured to:
associate a legitimacy score with one or more of a plurality of data signatures, wherein the first data signature is identified as being associated with the corrupted dataset based on the legitimacy score being lower than a threshold value.

12. The apparatus of claim 6, wherein the at least one processor is further configured to:
filter at least one dataset associated with the first data signature from the plurality of datasets for training the ML model based on a use case of the ML model.

13. The apparatus of claim 1, further comprising a transceiver coupled to the at least one processor, wherein the at least one processor is further configured to:
transmit the plurality of datasets assigned with the at least one data signature to a core network.

14. An apparatus for wireless communication at a core network, comprising:
a memory; and
at least one processor coupled to the memory and, based at least in part on information stored in the memory, the at least one processor is configured to:
obtain a plurality of datasets for training a machine learning (ML) model from at least one network node, each dataset being assigned with a corresponding data signature and each dataset including a set of metrics collected by a user equipment (UE) served by the at least one network node;
identify a first data signature associated with a corrupted dataset; and
filter out at least one dataset associated with the first data signature from the plurality of datasets for training the ML model based on the first data signature being associated with the corrupted dataset.

15. The apparatus of claim 14, wherein the at least one processor is further configured to:
instruct the at least one network node to assign the corresponding data signature to datasets obtained by the at least one network node.

16. The apparatus of claim 14, wherein the corresponding data signature comprises at least one of:
time or location of data collection,
a first identifier (ID) of a corresponding UE that is a source of a corresponding dataset,
a second ID of a network node associated with the corresponding UE,
a power class of the corresponding UE,
a vendor of the corresponding UE,
a component of the corresponding UE,
age of the corresponding UE, or
a model or a type of a sensor that collected a metric.

17. The apparatus of claim 14, wherein the at least one processor is further configured to:
train a first ML model using a first dataset of the plurality of datasets; and
apply a trusted testing dataset to the first ML model and a trusted ML model, the trusted ML model being trained using a trusted training dataset,
wherein the first dataset is identified as the corrupted dataset based on a performance difference between the first ML model and the trusted ML model being greater than a first threshold value.

18. The apparatus of claim 17, wherein the first dataset is identified as being associated with the corrupted dataset based on a distribution or statistical property of the first dataset differing by more than a second threshold value from the trusted training dataset.

19. The apparatus of claim 14, wherein the at least one processor is further configured to:
generate a plurality of dataset groups from the plurality of datasets based on a plurality of data signatures, each dataset groups being associated with one data signature of the plurality of data signatures; and
train a plurality of ML models using a plurality of dataset group combinations, each dataset group combination including more than one dataset groups of the plurality of dataset groups,
wherein the first data signature is identified as being associated with the corrupted dataset based on a first subset of ML models trained using a second subset of dataset group combination including a first dataset group associated with the first data signature having lower performances than the plurality of ML models other than the first subset of the ML models.

20. The apparatus of claim 14, wherein one or more of a plurality of data signatures are associated with legitimacy scores, and the first data signature is identified as being associated with the corrupted dataset based on a legitimacy score being lower than a threshold value.

21. The apparatus of claim 14, wherein the corrupted dataset associated with the first data signature is filtered out from the plurality of datasets for training the ML model based on a use case of the ML model.

22. The apparatus of claim 14, wherein the at least one processor is further configured to:
instruct the at least one network node to filter out the corrupted dataset associated with the first data signature.

23. An apparatus for a wireless communication at a user equipment (UE), comprising:
a memory; and
at least one processor coupled to the memory and, based at least in part on information stored in the memory, the at least one processor is configured to:
receive a configuration from a network node assigning at least one data signature to be reported with a dataset for a machine learning (ML) model; and
transmit one or more datasets for the ML model to the network node and indicating the at least one data signature for the dataset.

24. The apparatus of claim 23, wherein the at least one data signature comprises at least one of:
time or location of data collection,
a first identifier (ID) of the UE,
a second ID of the network node associated with the UE,
a power class of the UE,
a vendor of the UE,
a component of the UE,
age of the UE, or
a model or a type of a sensor that collects data.

25. A method of wireless communication at a network node, comprising:
obtaining a plurality of datasets for training a machine learning (ML) model from at least one user equipment (UE), each dataset including a set of metrics collected by a corresponding UE from the at least one UE; and
assigning at least one data signature associated with a source to each dataset of the plurality of datasets.

26. The method of claim 25, wherein the at least one data signature indicates one or more of:
time or location of data collection,
a first identifier (ID) of the corresponding UE associated with a corresponding dataset,
a second ID of the network node,
a power class of the corresponding UE,
a vendor of the corresponding UE,
a component of the corresponding UE,
age of the corresponding UE, or
a model or a type of a sensor that collected a metric.

27. The method of claim 25, further comprising:
identifying a first data signature associated with a corrupted dataset; and
filtering out at least one dataset associated with the first data signature from the plurality of datasets for training the ML model based on the first data signature being associated with the corrupted dataset.

28. The method of claim 27, further comprising:
training a first ML model using a first dataset of the plurality of datasets; and
applying a trusted testing dataset to the first ML model and a trusted ML model, the trusted ML model being trained using a trusted training dataset,
wherein the first dataset is identified as the corrupted dataset based on a performance difference between the first ML model and the trusted ML model being greater than a threshold value.

29. The method of claim 27, further comprising:
generating a plurality of dataset groups from the plurality of datasets based on a plurality of data signatures, each dataset groups being associated with one data signature of the plurality of data signatures; and
training a plurality of ML models using a plurality of dataset group combinations, each dataset group combination including more than one dataset groups of the plurality of dataset groups,
wherein the first data signature is identified as being associated with the corrupted dataset based on a first subset of ML models trained using a second subset of dataset group combination including a first dataset group associated with the first data signature having lower performances than the plurality of ML models other than the first subset of the ML models.

30. The method of claim 27, further comprising:
associating a legitimacy score with one or more of a plurality of data signatures, wherein the first data signature is identified as being associated with the corrupted dataset based on the legitimacy score being lower than a threshold value.
